(19) United States
(12) Patent Application Publication
(10) Pub. No.: US 2009/0006098 A1
(43) Pub. Date: Jan. 1, 2009

(54) Text-to-speech apparatus

(75) Inventors: Rika Nishiike, Kawasaki (JP); Hitoshi Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/215,403

(22) Filed: Jun. 27, 2008

(30) Foreign Application Priority Data
Jun. 28, 2007 (JP) 2007-170520

(51) Int. Cl. G10L 13/00

(52) U.S. Cl. 704/260; 704/E13.001

(57) ABSTRACT

According to an aspect of an embodiment, an apparatus for converting text data into sound signal, comprises: a phoneme determiner for determining phoneme data corresponding to a plurality of phonemes and pause data corresponding to a plurality of pauses to be inserted among a series of phonemes in the text data to be converted into sound signal; a phoneme length adjuster for modifying the phoneme data and the pause data by determining lengths of the phonemes, respectively in accordance with a speed of the sound signal and selectively reducing the length of at least one of the pause in the text data to a pause length which is less than the pause length corresponding to the speed of the sound signal; and an output unit for outputting sound signal on the basis of the adjusted phoneme data and pause data by the phoneme length adjuster.

### BACKGROUND OF THE INVENTION

1. Field of the Invention

The present invention relates to a text to speech reading apparatus, program, and method for converting text data including phonogram into sounds and outputting the sounds, and more specifically to a text to speech reading apparatus, program, and method capable of controlling a phoneme length in accordance with a reading rate, in particular, capable of maintaining or shortening a particular phoneme length upon low-speed reading.

2. Description of the Related Art

A so-called text to speech reading technique has been known. This technique analyzes text data including phonogram and executes voice synthesis using the text data based on a speech synthesis method to output the text data in the form of voice. In the field of portable terminal devices such as a cell phone, a speech synthesis function of reading a free text such as an e-mail message has been gradually brought into widespread use. In the field of personal computers (PCs), software called “screen reader” has been gradually popularized. Considering the case of understanding the content of a text, a length of phoneme representing a vowel, a consonant, a pause, etc. is an important factor for facilitating recognition.

In relation to such a text to speech reading technique, Japanese Laid-open Patent Publication No. 6-149283 discloses the following speech synthesis technique. According to this technique, if utterance speed information is below a preset value, a mora length is minimized to set an utterance speed higher than a standard one based on the information and set a short frame period corresponding to the utterance speed information. On the other hand, if utterance speed information is not less than a preset value, a long mora length is set in accordance with the utterance speed information to set the utterance speed lower than a standard one based on the information and maximize a frame period.

If a reading rate (speaking rate) is changeable, a length of each phoneme is set in inverse proportion to the speaking rate. For example, a speaking rate is twice a normal one, a phoneme length becomes ½ of a normal one. If a speaking rate is ½ of a normal one, a phoneme length is twice a normal one. Assuming that a relationship between the speaking rate and the phoneme length is simplified in this way, in other words, the speaking rate and the phoneme length are merely in inverse proportion, there is a possibility of hindering smooth recognition such that some sounds are hard to hear upon high- or low-speed reading albeit not strange (easy to hear) at a general speaking rate.

Japanese Laid-open Patent Publication No. 6-149283 discloses and suggests neither such requests or problems nor any construction for solving such problems.

### SUMMARY

According to an aspect of an embodiment, an apparatus for converting text data into sound signal, comprises: a phoneme determiner for determining phoneme data corresponding to a plurality of phonemes and pause data corresponding to a plurality of pauses to be inserted among a series of phonemes in the text data to be converted into sound signal; a phoneme length adjuster for modifying the phoneme data and the pause data by determining lengths of the phonemes, respectively in accordance with a speed of the sound signal and selectively reducing the length of at least one of the pause in the text data to a pause length which is less than the pause length corresponding to the speed of the sound signal; and an output unit for outputting sound signal on the basis of the adjusted phoneme data and pause data by the phoneme length adjuster.

### BRIEF DESCRIPTION OF THE DRAWINGS

FIG. 1 is a block diagram showing a configuration example of a text to speech reading apparatus according to a first embodiment of the present invention;

FIG. 2 is a block diagram showing a configuration example of a phoneme length control unit of the text to speech reading apparatus;

FIG. 3 is a block diagram showing an example of a portable terminal device incorporating the text to speech reading apparatus;

FIG. 4 shows a configuration example of the portable terminal device;

FIG. 5 shows a screen display example;

FIG. 6 is a flowchart showing an example of a phoneme length control processing procedure of the first embodiment;

FIG. 7 is a flowchart showing an example of a phoneme length control processing procedure according to a second embodiment of the present invention;

FIG. 8 is a flowchart showing an example of a phoneme length control processing procedure according to a third embodiment of the present invention;

FIG. 9 is a block diagram showing a phoneme length control unit according to a fourth embodiment of the present invention;

FIG. 10 is a flowchart showing an example of a phoneme length control processing procedure of the fourth embodiment;

FIG. 11 is a block diagram showing a phoneme length control unit according to a fifth embodiment of the present invention;

FIG. 12 is a flowchart showing an example of a phoneme length control processing procedure of the fifth embodiment;

FIG. 13 is a flowchart showing an example of a phoneme length control processing procedure according to a sixth embodiment of the present invention;

FIG. 14 is a flowchart showing an example of a phoneme length control processing procedure according to a seventh embodiment of the present invention;

FIG. 15 is a flowchart showing an example of a phoneme length control processing procedure according to an eighth embodiment of the present invention;

FIG. 16 is a flowchart showing an example of a phoneme length control processing procedure according to a ninth embodiment of the present invention;

FIG. 17 is a flowchart showing an example of a phoneme length control processing procedure according to a tenth embodiment of the present invention;

FIG. 18 is a flowchart showing an example of a phoneme length control processing procedure according to an eleventh embodiment of the present invention;

FIG. 19 is a flowchart showing an example of a phoneme length control processing procedure according to a twelfth embodiment of the present invention;

FIG. 20 is a flowchart showing an example of a phoneme length control processing procedure according to a thirteenth embodiment of the present invention;

FIG. 21 is a block diagram showing a parameter generating unit provided with a speaking rate adjustment unit;

FIG. 22 is a flowchart showing an example of a phoneme length control processing procedure according to the other embodiments of the present invention;

FIG. 23 is a flowchart showing an example of a phoneme length control processing procedure according to the other embodiments of the present invention;

FIG. 24 is a flowchart showing an example of a phoneme length control processing procedure;

FIG. 25 shows a language processing result;

FIGS. 26a and 26b, respectively, show a synthesized voice waveform;

FIGS. 27a and 27b, respectively, show a synthesized voice waveform;

FIGS. 28a and 28b, respectively, show a synthesized voice waveform;

FIGS. 29a and 29b, respectively, show a synthesized voice waveform;

FIGS. 30a and 30b, respectively, show a synthesized voice waveform;

FIGS. 31a and 31b, respectively, show a synthesized voice waveform; and

FIGS. 32a and 32b, respectively, show a synthesized voice waveform.

### DESCRIPTION OF THE PREFERRED EMBODIMENTS

### First Embodiment

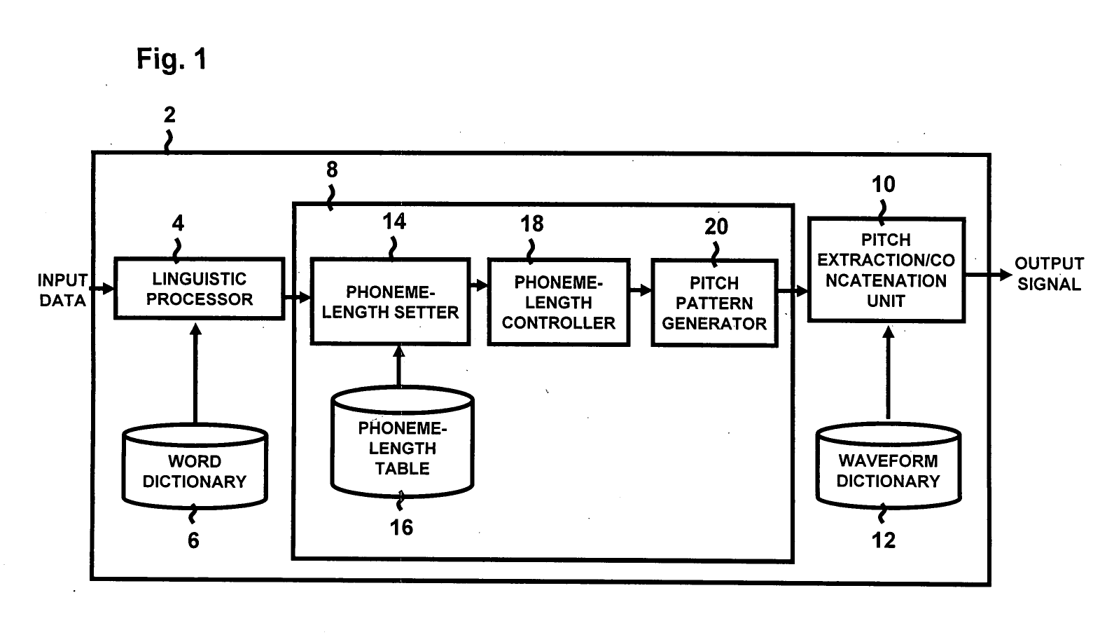

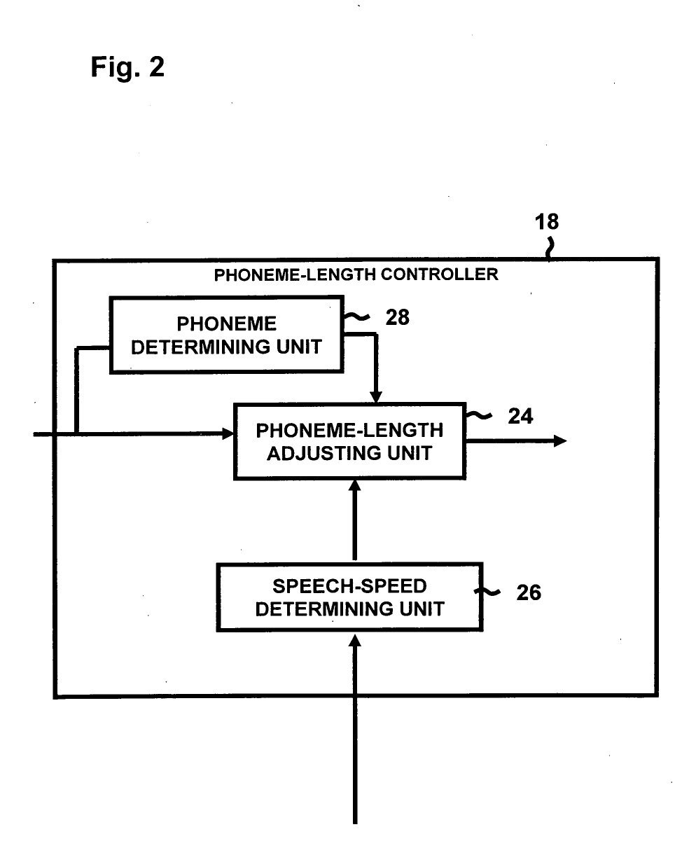

Referring to FIGS. 1 and 2, a first embodiment of the present invention is described below. FIG. 1 is a block diagram showing a configuration example of a text to speech reading apparatus. FIG. 2 is a block diagram showing a configuration example of a phoneme length control unit of the text to speech reading apparatus.

A text to speech reading apparatus (speech read-aloud device, speech reading apparatus) 2 is an example of a text to speech reading apparatus, program, and method of the present invention. The text to speech reading apparatus 2 is configured using a computer, for example, a speech synthesis apparatus for converting text data including a pause, a prolonged sound, a geminate consonant, or a consonant such as a text (in Japanese, kana/kanji mixed sentences) into sounds and reading text data by voice. The text to speech reading apparatus 2 controls a length of phoneme in the text data like a pause, a prolonged sound, a geminate consonant (Japanese sokuon), or a consonant in accordance with a speaking rate (reading rate) to thereby improve clearness of output sounds obtained by converting the text data and facilitate recognition of a synthesized voice (read speech). Here, the text data is a target for text to speech conversion. This data includes photogram inclusive of a pause, a prolonged sound, a geminate consonant, or a consonant, and a string thereof. The photogram or its string is an intermediate language composed of phonetic symbols with a prosodic symbol, that is, phonetic symbol with a prosodic symbol (kana). The pause is a “silence” that is an unvoiced duration such as a duration that is not converted to any sound (excluding a pause just before a plosive sound or a geminate consonant). For example, in such a Japanese sentence that “so tsugyoshi te, shinyou kin koni . . . ” (in Roman letters), a punctuation“,” as a silent duration is inserted between “so tsugyoshi te” and “shinyou kin koni”. Japanese sentence “so tsugyoshi te, shinyou kin koni . . . ” means “after (he) graduated from (high school), (he has worked) at a bank . . . ”. In other words, “so tsugyoshi te” means “after graduation” and “shinyou kin koni” means “at a bank”. The pause is exemplified by this punctuation. To describe a relationship between the pause and a “phrase”, the phrase is a unit duration corresponding to our utterance given in one breath. The aforementioned pause is inserted at breathing positions before and after the phrase.

The prolonged sound is a lengthened sound that is not limited to a short duration sound. The geminate consonant is a stop-plosive or fricative sound having the same articulation as the first consonant of the following syllable in a speech. This geminate consonant is, for example, “kk” of “sakki”. In addition, we produce the geminate consonant by exhaling a breath through a stopper of the vocal organ (closed or narrowed portion) in contrast to a vowel.

To attain the above function, as shown in FIG. 1, the text to speech reading apparatus 2 includes a language processing unit (linguistic processor) 4, a word dictionary 6, a parameter generating unit (parameter generator) 8, a pitch extracting/overlapping unit (pitch extracting/overlapping unit) 10, and a waveform dictionary 12.

The language processing unit 4 is language processing means for analyzing words of an input kanji/kana mixed sentence with reference to the word dictionary 6 to determine how to read each word, an accent, and an intonation to output a phonogramic string (intermediate language). Further, the word dictionary 6 stores the kind of each word (part of speech), how to read each word, and which word is accented.

The accent and intonation physically have an intimate relationship with a time-varying pattern of a pitch frequency. More specifically, the pitch frequency becomes high in an accented word or with a rising intonation. Therefore, the language processing unit 4 divides an input text to the above phrases based on punctuations in the input text or clauses extracted through word analysis.

The parameter generating unit 8 is parameter generating means for setting a phoneme duration, a pause duration, or a pitch frequency pattern. The parameter generating unit 8 controls a phoneme length according to a speaking rate.

As shown in FIG. 1, the parameter generating unit 8 is provided with a phoneme length setting unit (phoneme-length setter) 14, a phoneme length table 16, a phoneme length control unit (phoneme-length controller) 18, and a pitch pattern generating unit (pitch pattern generator) 20.

The parameter generating unit 8 determines which phoneme is subjected to speech synthesis at the stage where the language processing unit 4 generates the phonogram string. Thus, the phoneme length setting unit 14 as phoneme length setting means sets a phoneme length at a standard speaking rate. The phoneme length table 16 is means for storing phoneme lengths of a target phoneme and precedent and subsequent phonemes at a standard speaking rate. To describe a setting example of the phoneme length, the phoneme length table 16 prestores phoneme lengths of a target phoneme and precedent and subsequent phonemes (value extracted from a database) at a standard speaking rate, and a target phoneme length is set based on the prestored values. The phoneme length may be corrected using the other parameters.

The phoneme length control unit 18 is phoneme length control means for controlling the phoneme length at a standard speaking rate, which is set with the phoneme length setting unit 14, in accordance with an actual speaking rate. The speaking rate is given to the phoneme length control unit 18 as control information from means for adjusting a reading rate (not shown) (user settings etc.).

As shown in FIG. 2, the phoneme length control unit 18 includes a phoneme length adjusting unit (phoneme-length adjusting unit) 24, a speaking rate determining unit (speech-speed determining unit, speech rate determining unit) 26, and a phoneme determining unit 28. The phoneme length adjusting unit 24 receives determination results from the speech rate determining unit 26 and the phoneme determining unit 28 to adjust a phoneme length or a pause length. The speech rate determining unit 26 analyzes an input speaking rate to determine whether the speaking rate is a standard speed, a high speed, or a low speed, and sends a determination result to the phoneme length adjusting unit 24. In this case, the determination result of the speech rate determining unit 26 indicates a standard speed, a high speed, or a low speed. Further, the phoneme determining unit 28 determines whether any phoneme or pause is fronted in text data, for example, as well as a phoneme having a phoneme length set with the phoneme length setting unit 14 (FIG. 1) or pause, and then sends the determination result to the phoneme length adjusting unit 24.

According to the phoneme length control unit 18, if a phoneme length is inversely proportional to any speaking rate that is determined on the basis of a standard speaking rate, more specifically, if a speaking rate of 14 morae/sec is set based on a standard rate of, for example, 7 morae/sec, each phoneme length is set to ½; if a speaking rate of 6 morae/sec is set, each phoneme length is set to 7/6. Here, the mora refers to a beat and almost corresponds to one kana character. A contracted sound (small kana characters “ya”, “yu”, and “yo”, “kya”) corresponds to 1 mora. In Japanese, a length of one character almost corresponds to 1 mora.

The pitch pattern generating unit 20 is pattern generating means for setting a pitch frequency in each phoneme in consideration of accent information of a phonogram string.

The pitch extracting/overlapping unit 10 is pitch extracting/overlapping means using PSOLA (pitch-synchronous overlap-add: pitch conversion method based on waveform multiplexing). The waveform dictionary 12 stores a voice waveform, a phoneme label representing a relationship between each portion of the waveform and a phoneme, and a pitch mark representing a pitch frequency of a voiced sound. The pitch extracting/overlapping unit 10 extracts a voice waveform corresponds to 2 cycles from the waveform dictionary 12 based on parameters generated with the parameter generating unit 8 to multiply the waveform by a window function (for example, hanning window) and optionally by a gain for amplitude adjustment. Then, if a desired pitch frequency does not match a pitch frequency stored in the waveform dictionary 12, the pitch extracting/overlapping unit 10 makes the extracted waveform overlap and add therewith to output a synthesized audio signal.

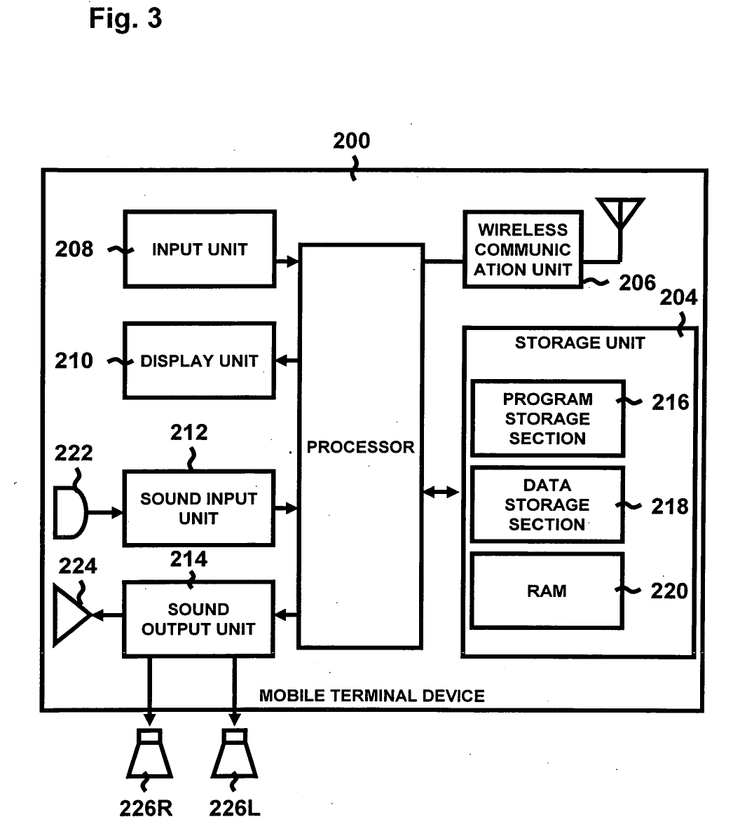

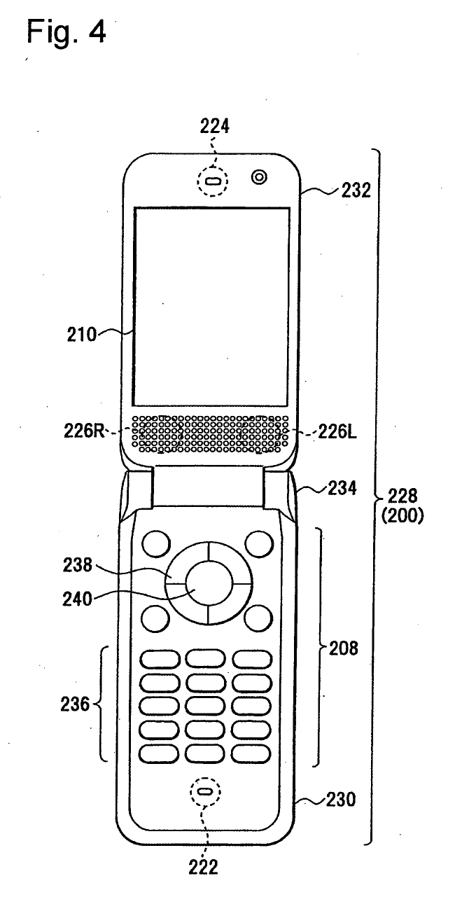

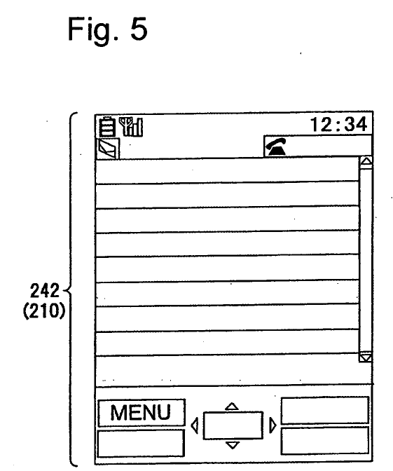

Referring to FIGS. 3, 4, and 5, hardware components of the text to speech reading apparatus are described next. FIG. 3 is a block diagram showing an example of a portable terminal device incorporating the text to speech reading apparatus. FIG. 4 shows a configuration example of the portable terminal device. FIG. 5 shows a screen display example.

A portable terminal device (mobile terminal device, portable terminal device) 200 exemplifies the application of the text to speech reading apparatus 2, and thus its configuration does not limit a text to speech reading apparatus, method, or program of the present invention. The portable terminal device 200 has a communication function or a function of converting text data, for example, a text such as an e-mail message (kanji/kana mixed sentence in Japanese) into sounds and outputting the sounds. Thus, as shown in FIG. 3, the portable terminal device 200 is provided with a processor 202, a storage unit 204, a wireless unit (wireless communication unit, radio unit) 206, an input unit 208, a display unit 210, a voice input unit (speech input unit, sound input unit) 212, and a voice output unit (speech output unit, sound output unit) 214.

The processor 202 is control means for controlling telephone communication, a text to speech reading operation such as speech synthesis, or other such operations. The processor 202 includes a CPU (central processing unit) or an MPU (microprocessor unit), and executes an OS (operating system) or application programs in the storage unit 204. The application programs include a program for executing a text-to-speech reading processing procedure.

The storage unit 204 is a recording medium that stores programs executed by the processor 202 or various kinds of data used for executing the programs as well as defines a processing area. The unit includes a program storage unit 216, a data storage unit 218, and a RAM (random access memory 220. The program storage unit 216 stores an OS or application programs. The data storage unit 218 includes the word dictionary 6, the waveform dictionary 12, and the phoneme length table 16 (FIG. 1) and stores the aforementioned data. The RAM 220 provides a work area.

The wireless unit 206 is wireless communication means for transmitting/receiving audio signal waves or packet signal waves by radio to/from a base station. The unit is controlled by the processor 202.

The input unit 208 is means for inputting responses to a dialog extended on the display unit 210 or control data through user's manipulation. The unit includes a keyboard and a touch panel.

The display unit 210 is display means that is controlled by the processor 202 and displays text or graphical data. The unit includes, for example, an LCD (liquid crystal display) element. The display unit 210 displays text data used for text to speech conversion.

The voice input unit 212 is voice input means controlled by the processor 202. The unit includes a microphone 222. An input voice is converted to an audio signal through a microphone 222, and the audio signal is converted to a digital signal and input to the processor 202.

The voice output unit 214 is voice output means controlled by the processor 202. The unit includes a receiver 224 and speakers 226R and 226L as voice converting means. A synthesized voice generated through text to speech conversion is reproduced using the receiver 224, and the speakers 226R and 226L.

In the portable terminal device 200, the above text to speech reading apparatus 2 includes, for example, the processor 202, the storage unit 204, the display unit 210, and the voice output unit 214.

As shown in FIG. 4, the portable terminal device 200 includes a first casing unit 230 and a second casing unit 232, which constitute a casing 228 by way of example. The casing units 230 and 232 are coupled with a hinge portion 234 in a foldable form. The casing unit 232 is provided with the display unit 210, the receiver 224, and the speakers 226R and 226L. The input unit 208 is provided with plural keys 236 used for inputting characters etc., a cursor key 238, and an enter key 240.

The text to speech reading operation of the portable terminal device 200 is targeted at various types of text such as an e-mail message or a novel. Sentences etc. extended on a screen of the display unit 210 are subjected to speech synthesis and reproduced with the receiver 224, and the speakers 226R and 226L. In this case, as shown in FIG. 5, an e-mail message is displayed on an e-mail message display screen 242 displayed on the display unit 210. This e-mail message is output by voice. In this example, a message “yamanashiken no koukou wo so tsugyoshi te shinyou kin koni haitte 4nenme desu.” is displayed and reproduced by voice. “yamanashiken no koukou wo so tsugyoshi te shinyou kin koni haitte 4nenme desu” represents Japanese pronunciation. A Japanese sentence “yamanashiken no koukou wo so tsugyoshi te shinyou kin koni haitte 4nen me desu” also means “after he graduated from high school, he has worked at a bank for 4 years” in English.

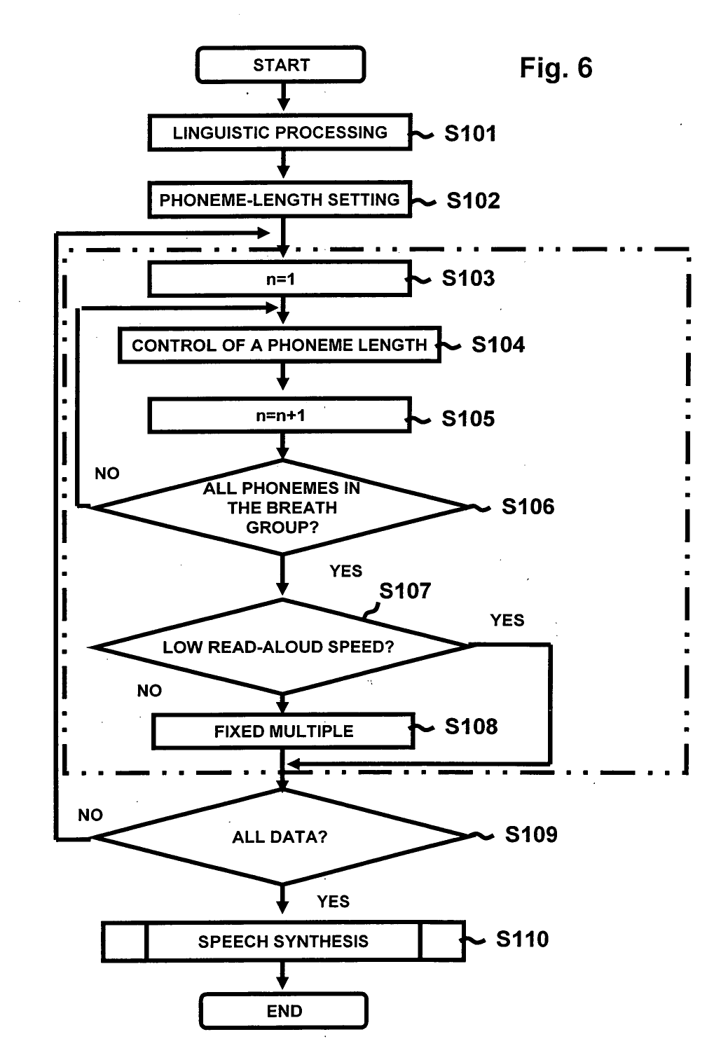

Next, how to control a phoneme length is described with reference to FIG. 6. FIG. 6 is a flowchart showing an example of a phoneme length control processing procedure according to the first embodiment.

This processing procedure exemplifies the text to speech reading program or method. In the first embodiment, the procedure includes a procedure or step of multiplying a phoneme length by a fixed value according to a speaking rate upon low-speed reading and of maintaining a length of the last pause in a phrase. This processing procedure is executed by the phoneme length control unit 18 (FIG. 2) of the text to speech reading apparatus 2 (FIG. 1).

As shown in FIG. 6, this processing procedure includes language processing (step S101) and phoneme length setting processing (step S102). The language processing (step S101) is executed by the language processing unit 4 to generate a phonogram string using input data. At this stage, which phoneme is used for speech synthesis is determined. Next, the phoneme length setting processing (step S102) is executed with the phoneme length setting unit 14 to set a phoneme length of each phoneme inclusive of a pause at a standard speaking rate. In this case, phoneme lengths of a target phoneme and precedent and subsequent phonemes at a standard speaking rate are set with reference to the phoneme length table 16.

After the above processing for setting a phoneme length, a phoneme number n is initialized (n=1) (step S103) to control a phoneme length in accordance with a speaking rate (steps S104 to S108). The phoneme length is controlled on a phrase basis, and a loop for processing phoneme in a phrase is composed of steps S103 to S108. The phoneme length control processing includes processing for determining a phoneme to be controlled and processing for adjusting a phoneme length based on the determination result.

The phoneme length control unit 18 analyzes input speaking rate information and multiplies a phoneme length by a fixed value according to the speaking rate (step S104). In this case, the pause length is multiplied by a fixed value according to the speaking rate. After such phoneme adjustment, a phoneme number n is updated (n=n+1) (step S105) to determine whether all phonemes in a frames have been processed, more specifically, whether the phoneme number n in a phrase reaches the number of phonemes n (step S106) to execute processing on all phonemes in the phrase.

After the completion of processing on all phonemes in the phrase, a speaking rate is determined, more specifically, it is determined whether a speaking rate is a low speed (step S107). If the speaking rate is not a low speed (NO in step S107), a length of the last pause in a phrase is multiplied by a fixed value (step S108). If the speaking rate is a low speed (YES in step S107), the processing skips step S108 and advances to determination as to termination of the processing (step S109). At the time of determining termination, it is determined whether all of the input data has been processed (step S109). The processing in steps S103 to S109 is repeated until the completion of processing all the input data. After the determination as to termination, speech synthesis is executed (step S110) and voice is output.

In this way, a phoneme length is set according to a speaking rate on a phrase basis. If a speaking rate is low, a length of the last pause is not increased according to a speaking rate, so the pause length is reduced compared with a prolonged phoneme upon low-speed reading, so a read speech does not sound drawn out and a reading time can be shortened.

### Second Embodiment

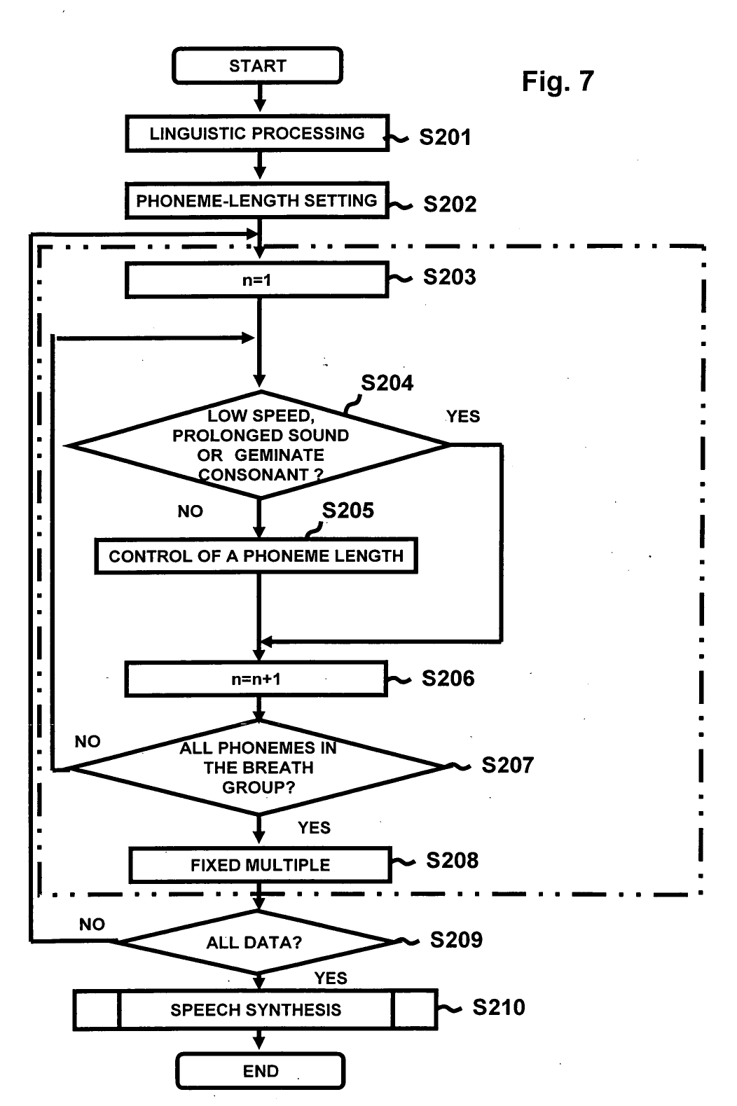

Next, a second embodiment of the present invention is described. FIG. 7 is a flowchart showing an example of a phoneme length control processing procedure of the second embodiment.

The processing procedure exemplifies the text to speech reading program or method and is executed using the above text to speech reading apparatus 2 (FIG. 1) and the phoneme length control unit 18 (FIG. 2). In the second embodiment, it is determined whether a speaking rate is low and whether a target sound is a prolonged sound or geminate consonant. Upon low-speed reading, lengths of phonemes other than the prolonged sound or geminate consonant are multiplied by a fixed value according to a speaking rate, while lengths of the prolonged sound or geminate consonant are not increased. In this way, lengths of the prolonged sound or geminate consonant are not changed as a standard length to thereby realize easy-to-hear sounds without increasing the total reproduction time too much upon reading text data.

In the second embodiment, in order to determine a phoneme to be lengthened, the phoneme determining unit 28 (FIG. 2) determines whether a target sound is a prolonged sound or geminate consonant to set the lengths of phonemes of the prolonged sound or geminate consonant to a standard length.

As shown in FIG. 7, in this processing procedure, language processing (step S201) and phoneme length setting processing (step S202) are carried out. After the processing procedure, language processing (step S201) and phoneme length setting processing (step S202), a phoneme number n is initialized (n=1) as processing of phonemes in a phrase (step S203).

After the initialization, it is determined whether a reading speed is low and a target phoneme is a prolonged sound or geminate consonant (step S204). If a reading speed is low and a target phoneme is not in a prolonged sound or geminate consonant (NO in step S204), a phoneme length is set according to a speaking rate (step S205). In other words, the phoneme length control unit 18 multiplies a phoneme length by a fixed value, based on input speaking rate information, in accordance with the speaking rate (step S205). If a reading speed is low and a target phoneme is a prolonged sound or geminate consonant (YES in step S204), step S205 is skipped and a phoneme number n is updated (n=n+1) (step S206) to determine whether all phonemes in a phrase have been processed (step S207) to execute processing on all phonemes in the phrase.

After the completion of processing phonemes in the phrase up to the last pause of the phrase, the pause length is multiplied by a fixed value according to the speaking rate (step S208), followed by determination as to termination (step S209). Until processing of all data is completed, steps S203 to S209 are repeated. After the determination as to termination, speech synthesis is carried out (step S210), and a voice is output.

In this way, a phoneme length is adjusted according to a speaking rate on a phrase basis. If the phonemes include that of a prolonged sound or geminate consonant, lengths of phonemes of the prolonged sound or geminate consonant are set to a standard length and are not increased to thereby realize easy-to-hear sounds and facilitate recognition of a read speech.

### Third Embodiment

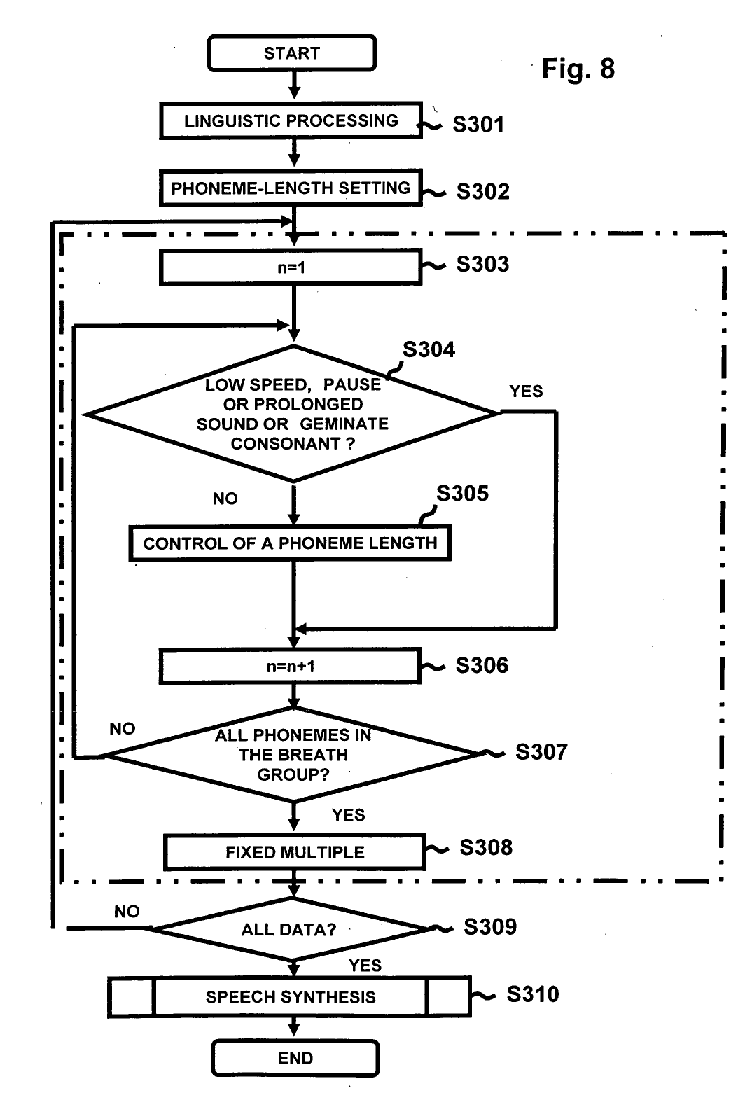

Next, a third embodiment of the present invention is described with reference to FIG. 8. FIG. 8 is a flowchart showing an example of a phoneme length control processing procedure of the third embodiment.

This processing procedure exemplifies the text to speech reading program or method and is executed using the above text to speech reading apparatus 2 (FIG. 1) and the phoneme length control unit 18 (FIG. 2). In the third embodiment, in addition to the adjustment of a phoneme length in the second embodiment, a pause length is set to a standard length, not increased to thereby realize easy-to-here sounds.

In the third embodiment, in order to determine a phoneme subjected to phoneme length adjustment, the phoneme determining unit 28 (FIG. 2) determines whether a target phoneme is a pause, or a prolonged sound or a geminate consonant to set the lengths of phonemes of the pause or the prolonged sound or geminate consonant to a standard length, not to increase the lengths.

Thus, in this processing procedure, as shown in FIG. 8, language processing (step S301) and phoneme length setting processing (step S302) are executed. After the language processing (step S301), the phoneme length setting processing (step S302), and the processing for setting a phoneme length, a phoneme number n is initialized (n=1) (step S303) as processing of phonemes in a phrase.

After the initialization, it is determined whether a reading rate is low and a target phoneme is a pause, or a prolonged sound or geminate consonant (step S304). If the reading rate is low and a target phoneme is not in a pause, or a prolonged sound or geminate consonant (NO in step S304), a phoneme length is set according to a speaking rate (step S305). More specifically, the phoneme length control unit 18 multiplies a phoneme length by a fixed value, based on input speaking rate information, according to the speaking rate (step S305). If a reading speed is low and a target phoneme is a pause or a prolonged sound or geminate consonant (YES in step S304), step 8305 is skipped and a phoneme number n is updated (n=n+1) (step S306) to determine whether all phonemes in a phrase have been processed (step S307) to execute processing on all phonemes in the phrase.

After the completion of processing phonemes in the phrase up to the last pause of the phrase, the pause length is multiplied by a fixed value according to the speaking rate (step S308), followed by determination as to termination (step S309). Until processing of all data is completed, steps S303 to S309 are repeated. After the determination as to termination, speech synthesis is carried out (step S310), and a voice is output.

In this way, a phoneme length is adjusted according to a speaking rate on a phrase basis. If the phonemes include that of a pause, or a prolonged sound or geminate consonant, lengths of phonemes of the pause or the prolonged sound or geminate consonant are set to a standard length and are not increased to thereby realize easy-to-hear sounds and facilitate recognition of a read speech.

### Fourth Embodiment

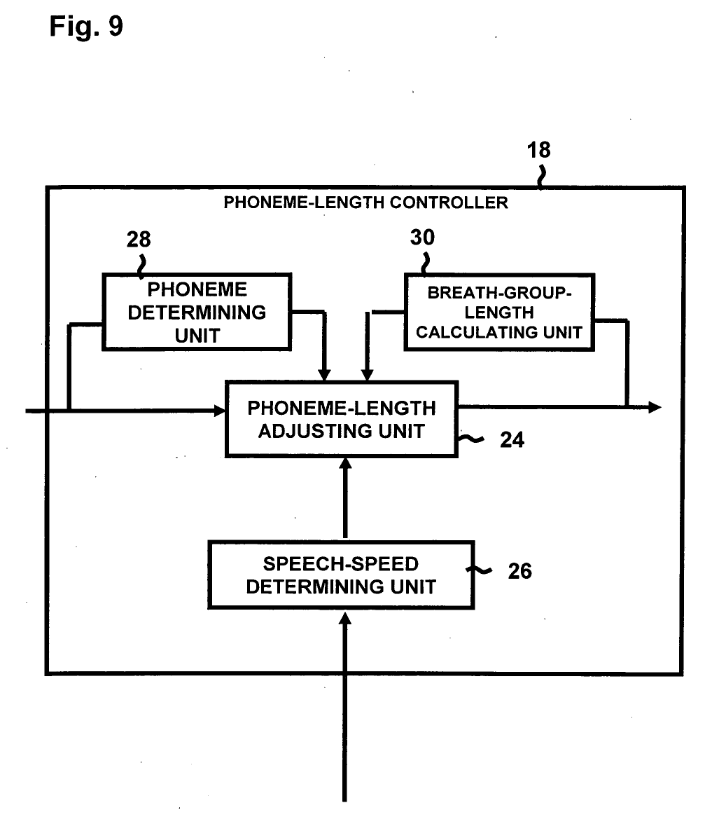

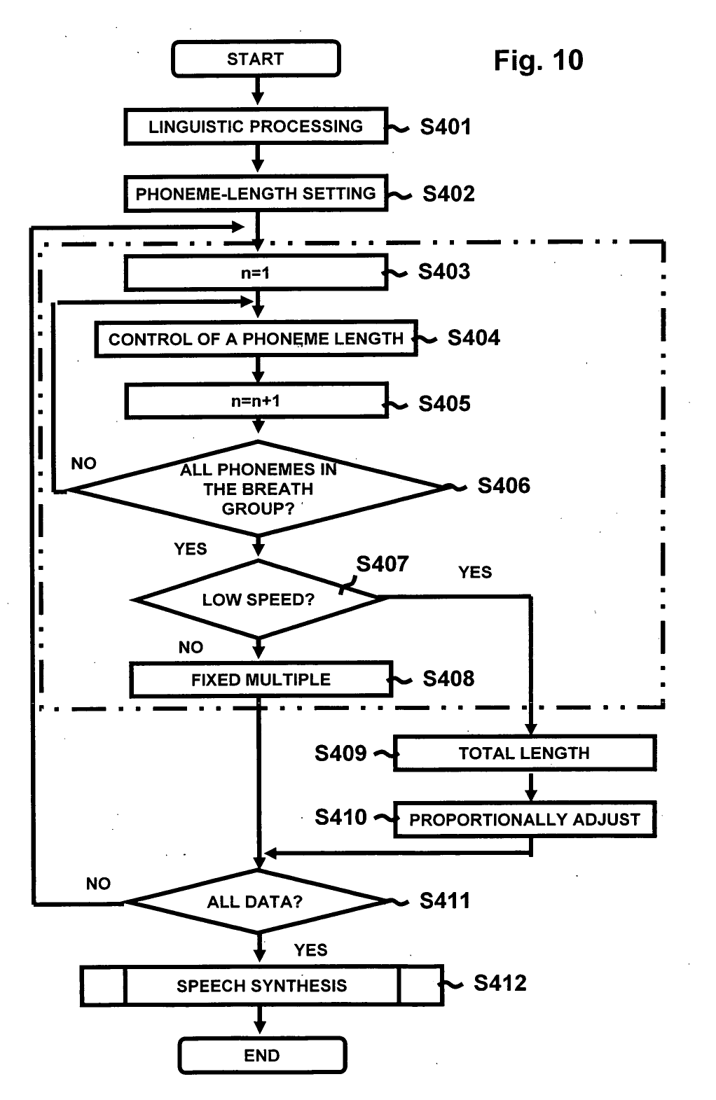

Next, a fourth embodiment of the present invention is described with reference to FIGS. 9 and 10. FIG. 9 is a block diagram showing a phoneme length control unit of the fourth embodiment. FIG. 10 is a flowchart showing an example of a phoneme length control processing procedure of the fourth embodiment. In FIG. 9, the same components as those of FIG. 2 are denoted by identical reference numerals.

This processing procedure exemplifies the text to speech reading program or method and is executed using the above text to speech reading apparatus 2 (FIG. 1) and the phoneme length control unit 18 (FIG. 2). In the fourth embodiment, in addition to the adjustment of a phoneme length in the first embodiment, a pause length is not increased upon low-speed reading, more specifically, lengths of phonemes other than a pause are increased relative to a prolonged phoneme of the pause, so the total length is maintained to prevent such a situation that a read speech sounds drawn out. To elaborate, the total length of a phrase is calculated and proportionally divided into a predetermined length and allocated to all phones but a pause to thereby prevent such a situation that a read speech sounds drawn out, and realize easy-to-hear sounds.

In the fourth embodiment, in the phoneme length control unit 18 (FIG. 2) of the text to speech reading apparatus 2 (FIG. 1), a phrase length calculating unit (breath-group-length calculating unit) 30 is provided to calculate the total length of a phrase based on data output from the phoneme length adjusting unit 24. The calculation result is sent to the phoneme length adjusting unit 24 as control information, and the phoneme length adjusting unit 24 multiplies a pause length by a fixed value according to a speaking rate and then calculates the total length of the phrase to proportionally allocate the increased length to all phonemes in the phrase such that a reading time for the phrase has a predetermined length.

As shown in FIG. 10, in this processing procedure, language processing (step S401) and phoneme length setting processing (step S402) are executed. After that, as processing of phonemes in a phrase, a phoneme number n is initialized (n=1) (step S403) and a phoneme length is controlled based on a speaking rate (steps S404 to S408). Similar to the first embodiment, the phoneme length is controlled on a phrase basis.

The phoneme length control unit 18 multiplies a phoneme length by a fixed value, based on input speaking rate information, according to the speaking rate (step S404). In this case, a pause length is also multiplied by a fixed value according to a speaking rate. After such phoneme adjustment, a phoneme number n is updated (n=n+1) (step S405) to determine whether all phonemes in a phrase have been processed, that is, whether the phoneme number n in the phrase reaches the number of phonemes n (step S406) to execute processing on all phonemes in the phrase.

After the completion of processing phonemes in the phrase, it is determined whether a reading rate is low (step S407). If a reading rate is not low (NO in step S407), when the processing proceeds up to the last pause in a phrase, the pause length is multiplied by a fixed value according to a speaking rate (step S408). On the other hand, if a reading rate is low (YES in step S407), the total length of the phrase is calculated (step S409), and a phoneme length is adjusted by proportionally allocating the length to all phonemes but a pause such that the length of the phrase is equal to or almost equal to the length obtained when a phoneme length is not increased (step S410), followed by determination as to termination (step S411). Until processing of all data is completed, steps S403 to S411 are repeated. After the determination as to termination, speech synthesis is carried out (step S412), and a voice is output.

In this way, instead of increasing a phoneme length of the last pause in a phrase upon low-speed reading, phonemes other than the pause are lengthened, (so a read speech does not sound drawn out and is easy to hear while the total length thereof is not changed.

### Fifth Embodiment

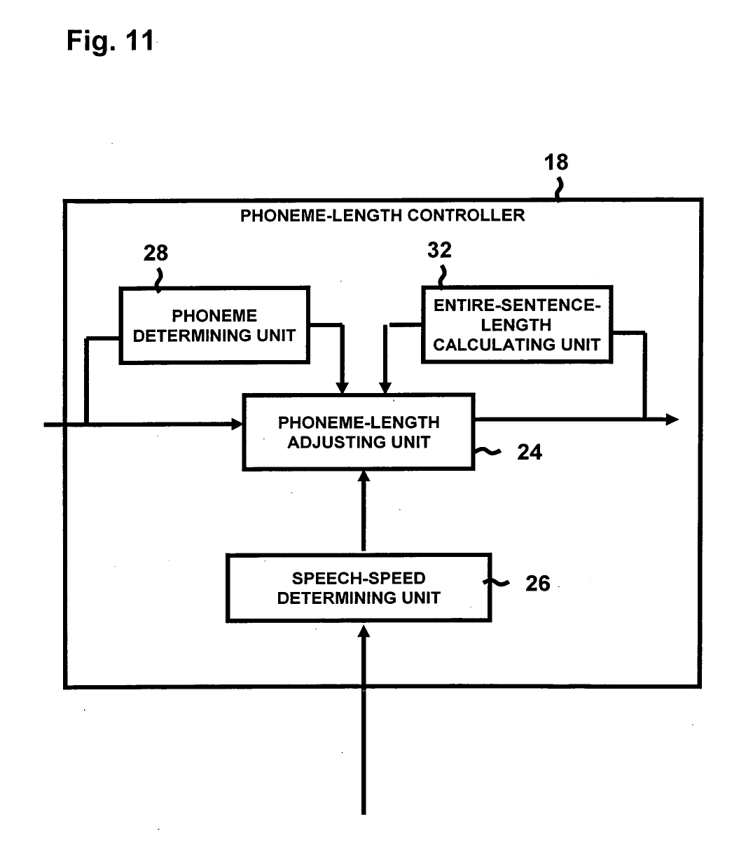

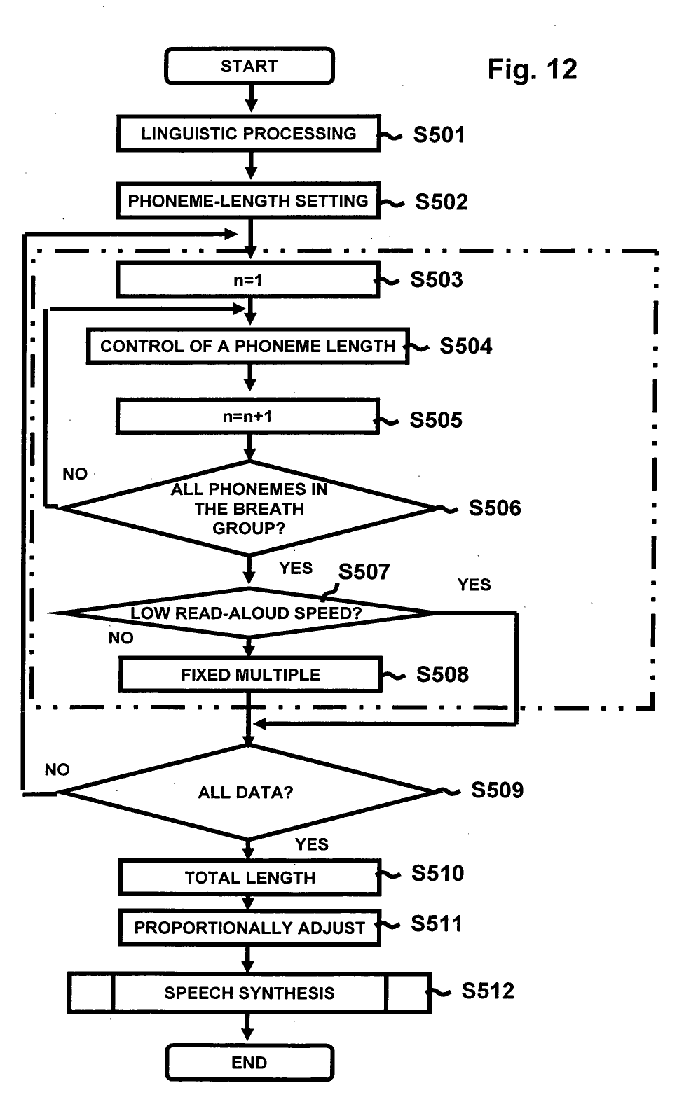

Next, a fifth embodiment of the present invention is described with reference to FIGS. 11 and 12. FIG. 11 is a block diagram showing a phoneme length control unit of the fifth embodiment. FIG. 12 is a flowchart showing an example of a phoneme length control processing procedure of the fifth embodiment. In FIG. 11, the same components as those of FIG. 2 are denoted by identical reference numerals.

This processing procedure exemplifies the text to speech reading program or method and is executed using the above text to speech reading apparatus 2 (FIG. 1) and the phoneme length control unit 18 (FIG. 2). In the fifth embodiment, in addition to the adjustment of a phoneme length in the first embodiment, a length of the last pause in a phrase is not increased upon low-speed reading, more specifically, the total text length is calculated with respect to a prolonged phoneme of the pause, and the total length is proportionally divided into a predetermined length and allocated to all phones to thereby prevent such a situation that a read speech sounds drawn out, and realize easy-to-hear sounds.

In the fifth embodiment, in the phoneme length control unit 18 (FIG. 2) of the text to speech reading apparatus 2 (FIG. 1), a total text length calculating unit (entire-sentence-length calculating unit) 32 is provided. This unit has the following function. That is, the total text length is calculated based on data output from the phoneme length adjusting unit 24. The calculation result is sent to the phoneme length adjusting unit 24 as control information, and the phoneme length adjusting unit 24 multiplies the pause length by a fixed value according to a speaking rate and then proportionally allocates the maintained or reduced length to all phonemes in the text to adjust a length of each phoneme such that a reading time for the phrase has a predetermined length.

As shown in FIG. 12, in this processing procedure, phoneme length setting processing (step S502) is executed. After that, as processing of phonemes in a phrase, a phoneme number n is initialized (n=1) (step S503) and a phoneme length is controlled based on a speaking rate (steps S504 to S508). Similar to the first embodiment, the phoneme length is controlled on a phrase basis.

The phoneme length control unit 18 multiplies a phoneme length by a fixed value, based on input speaking rate information, according to the speaking rate (step S504). In this case, a pause length is also multiplied by a fixed value according to a speaking rate. After such phoneme adjustment, a phoneme number n is updated (n=n+1) (step S505) to determine whether all phonemes in a phrase have been processed, that is, whether the phoneme number n in the phrase reaches the number of phonemes n (step S506) to execute processing on all phonemes in the phrase.

After the completion of processing phonemes in the phrase, it is determined whether a reading rate is low (step S507). If a reading rate is not low (NO in step S507), when the processing proceeds up to the last pause in a phrase, the pause length is multiplied by a fixed value according to a speaking rate (step S508). On the other hand, if a reading rate is low (YES in step S507), determination as to termination is executed (step S509). Upon the determination as to termination, whether processing of all data is completed is determined. After the determination as to termination, a phoneme length is adjusted by proportionally allocating the length to all phonemes such that the text length is equal to or almost equal to the length obtained when a phoneme length is not increased (step S511), followed by speech synthesis (step S512) to output a voice.

In this way, instead of increasing a phoneme length of the last pause in a phrase upon low-speed reading, phonemes are lengthened on a text basis, so a read speech does not sound drawn out and is easy to hear while the total length thereof is not changed.

### Sixth Embodiment

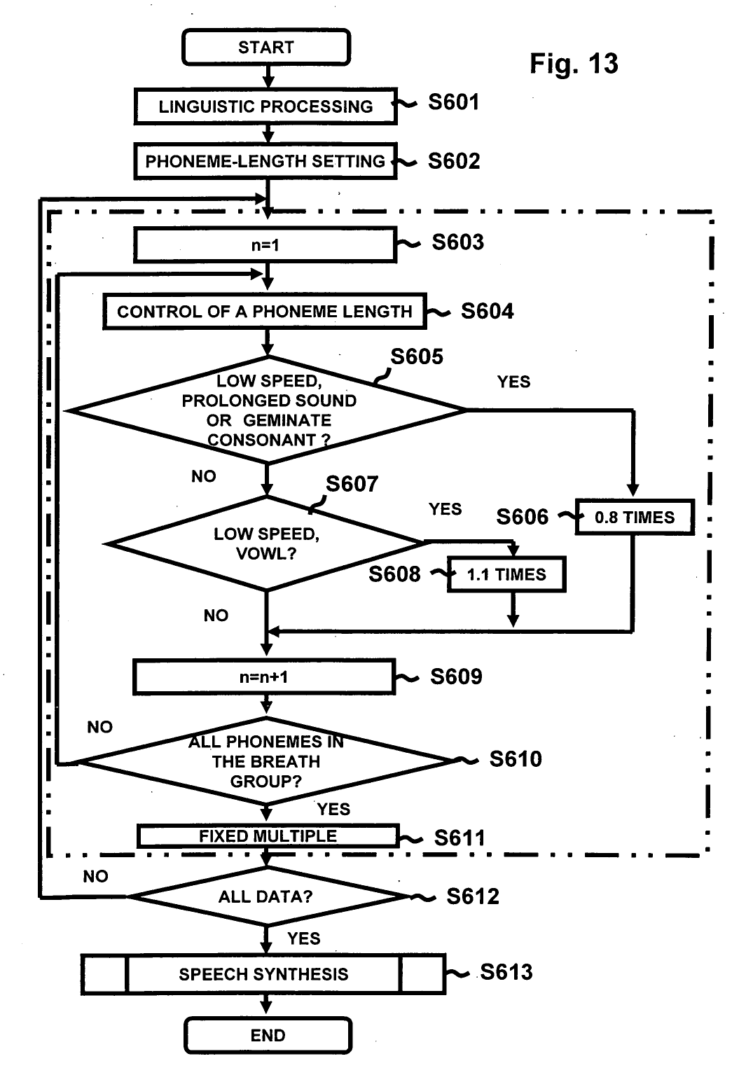

Next, a sixth embodiment of the present invention is described with reference to FIG. 13. FIG. 13 is a flowchart showing an example of a phoneme length control processing procedure of the sixth embodiment.

This processing procedure exemplifies the text to speech reading program or method and is executed using the above text to speech reading apparatus 2 (FIG. 1) and the phoneme length control unit 18 (FIG. 2). In the sixth embodiment, instead of shortening a phoneme of a prolonged sound or geminate consonant, a phoneme length of vowel is increased, so a read speech that is easier to hear is realized while the entire length is substantially maintained. In this case, a speaking rate upon low-speed reading is set to, for example, 0.8 times or less as high as a standard speed while a phoneme length is set to, for example, 0.8-fold as a fixed ratio to a standard phoneme length. Although the length of a phoneme of a prolonged sound or geminate consonant is decreased, the phoneme length of vowel is increased, so a read speech is easier to hear without increasing a time for text to speech conversion.

As shown in FIG. 13, in this processing procedure, language processing (step S601) and phoneme length setting processing (step S602) are executed. After that, as processing of phonemes in a phrase, a phoneme number n is initialized (n=1) (step S603) and a phoneme length is controlled based on a speaking rate (steps S604 to S611). Similar to the second embodiment (FIG. 7), the phoneme length is controlled on a phrase basis.

Also in the sixth embodiment, a phoneme length is multiplied by a fixed value according to the speaking rate (step S604). It is determined whether a reading speed is low and whether a phoneme is a prolonged sound or geminate consonant (step S605). If the reading speed is low and a phoneme is a prolonged sound or geminate consonant (YES in step S605), the phoneme length is multiplied by a predetermined value, for example, 0.8 (step S606). On the other hand, if the reading speed is low and a phoneme is not a prolonged sound or geminate consonant (NO in step S605), it is determined whether a reading speed is low and whether a phoneme is vowel (step S607). If the reading speed is low and a phoneme is vowel (YES in step S607), the phoneme length is multiplied by a predetermined value, for example, 1.1, that is, adjusted (step S608). On the other hand, if the reading speed is low and a phoneme is not vowel (NO in step S607), the phoneme length multiplied by a fixed value according to a speaking rate in step S604 is maintained.

Then, as described above, a phoneme number n is updated (n=n+1) (step S609). It is determined whether all phonemes in a phrase have been processed (step S610). When the processing proceeds up to the last pause in the phrase, the pause length is multiplied by a fixed value according to a speaking rate (step S611), followed by determination as to termination (step S612) and speech synthesis (step S613).

In this way, a phoneme length of a prolonged sound or geminate consonant is set shorter than a standard one, and a phoneme length of vowel is increased, so the entire length is substantially maintained without increasing the total reproduction time upon outputting a voice, a synthesized voice is easier to hear, and recognition of a read speech is facilitated.

### Seventh Embodiment

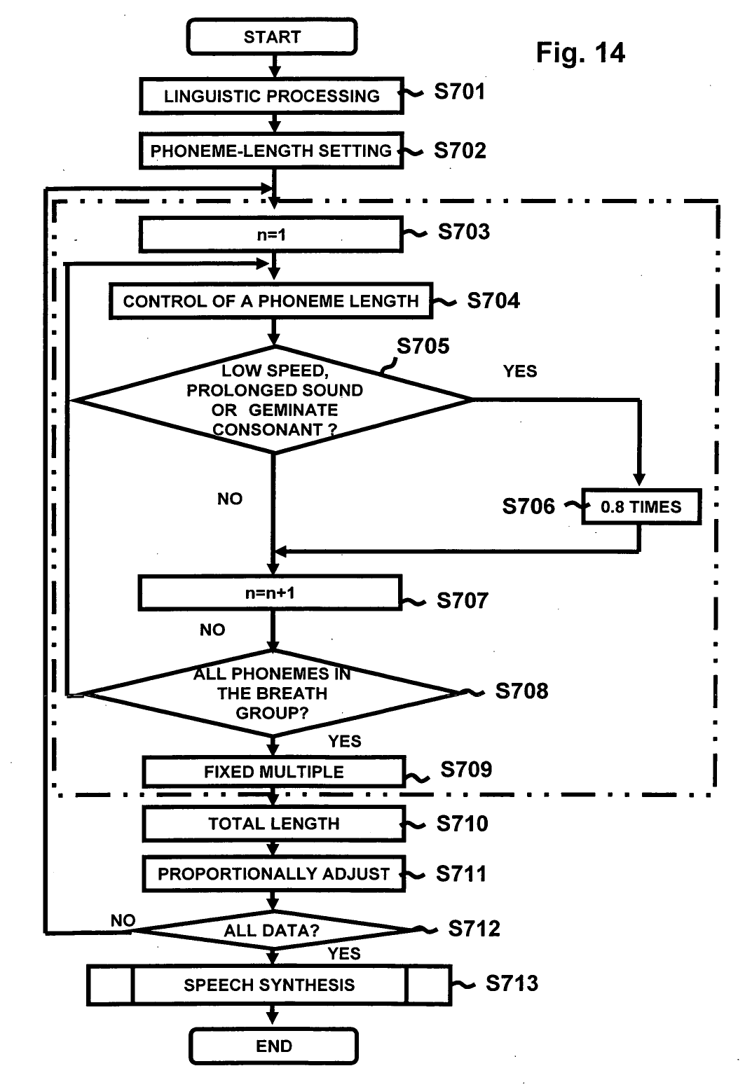

Next, a seventh embodiment of the present invention is described with reference to FIG. 14. FIG. 14 is a flowchart showing an example of a phoneme length control processing procedure of the seventh embodiment.

This processing procedure exemplifies the text to speech reading program or method and is executed using the above text to speech reading apparatus 2 (FIG. 1) and the phoneme length control unit 18 (FIG. 9). In the seventh embodiment, a phoneme of a prolonged sound or geminate consonant is shortened, and the reduced length is proportionally allocated to all phonemes but a prolonged sound or geminate consonant to increase the length. Thus, the length of a phrase is maintained, that is, a time for text to speech conversion is not increased while a read speech is made easier to hear. To give an example thereof, a speaking rate is set lower than 0.8 times as high as a standard speed, and a reduction ratio of a phoneme length is set to 0.8.

As shown in FIG. 14, in this processing procedure, language processing (step S701) and phoneme length setting processing (step S702) are executed. After that, as processing of phonemes in a phrase, a phoneme number n is initialized (n=1) (step S703) and a phoneme length is controlled based on a speaking rate (steps S704 to S709.

Similar to the second embodiment (FIG. 7), the phoneme length is controlled on a phrase basis.

Also in the seventh embodiment, a phoneme length is multiplied by a fixed value according to the speaking rate (step S704). It is determined whether a reading speed is low and whether a phoneme is a prolonged sound or geminate consonant (step S705). If the reading speed is low and a phoneme is a prolonged sound or geminate consonant (YES in step S705), the phoneme length is multiplied by a predetermined value, for example, 0.8 (step S706). On the other hand, if the reading speed is low and a phoneme is not a prolonged sound or geminate consonant (NO in step S705), the phoneme length multiplied by a fixed value according to a speaking rate in step S704 is maintained.

After such processing, a phoneme number n is updated (n n+1) (step S707), followed by determination as to completion of processing of phonemes in a phrase (step S708). After the length of the last pause in a phrase is multiplied by a fixed value according to a speaking rate (step S709), the total length of the phrase is calculated (step S710) to proportionally allocate the length to all phonemes but a pause such that the length of the phrase is equal to or almost equal to a predetermined length, for example, the length obtained when a phoneme length is not increased (step S711), followed by determination as to termination (step S712). Until processing of all data is completed, steps S703 to S712 are repeated. After the determination as to termination, speech synthesis is carried out (step S713), and a voice is output.

In this way, a phoneme length is multiplied by a fixed value according to a speaking rate and then, if a reading speed is low and a phoneme is a prolonged sound or geminate consonant, the phoneme length is set shorter than a preset one. After the total phoneme length of a phrase is calculated, the shortened length is proportionally allocated to all phonemes but a prolonged sound or geminate consonant in a phrase to increase the length. Thus, the phrase length is maintained and in addition, a read speech is easier to hear and recognition of a read speech is facilitated.

### Eighth Embodiment

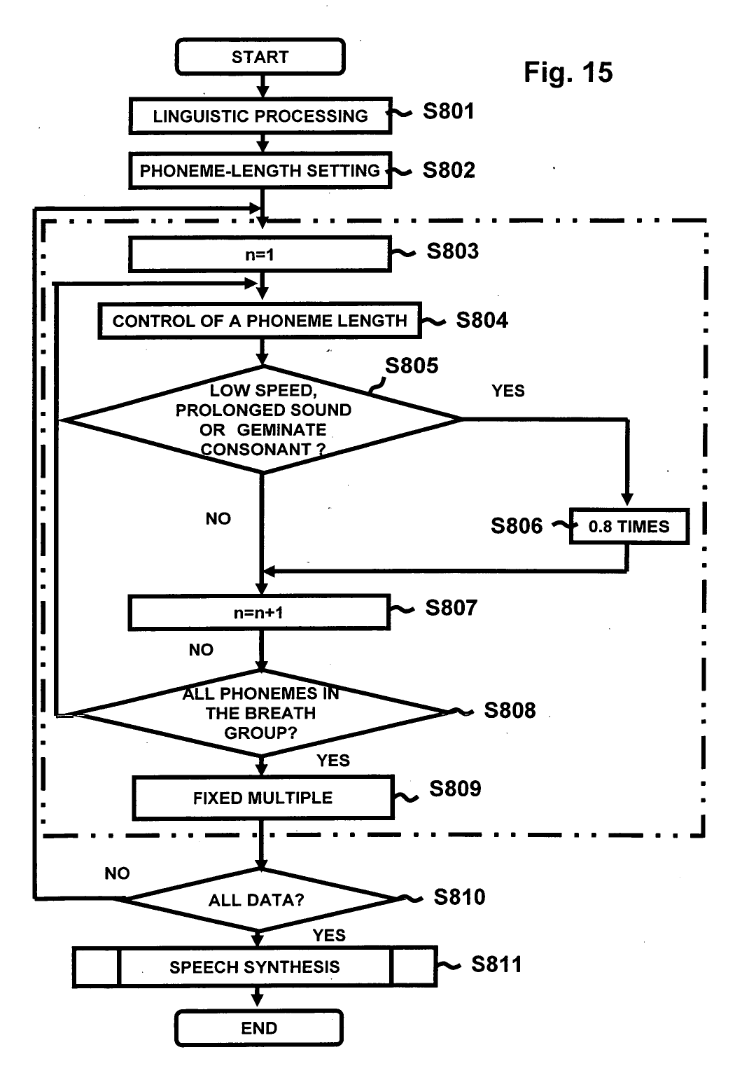

Next, an eighth embodiment of the present invention is described with reference to FIG. 15. FIG. 15 is a flowchart showing an example of a phoneme length control processing procedure of the eighth embodiment.

This processing procedure exemplifies the text to speech reading program or method and is executed using the above text to speech reading apparatus 2 (FIG. 1) and the phoneme length control unit 18 (FIG. 2). In the eighth embodiment, if a reading rate is low and a phoneme is a prolonged sound or geminate consonant, the phoneme length is shortened but lengths of the other phonemes are not shortened, a read speech that is easier to hear is realized while the entire length is substantially maintained, that is, a text to speech conversion time is not increased.

As shown in FIG. 15, in this processing procedure, language processing (step S801) and phoneme length setting processing (step S802) are executed. After that, as processing of phonemes in a phrase, a phoneme number n is initialized (n=1) (step S803) and a phoneme length is controlled based on a speaking rate (steps S804 to S809). Similar to the second embodiment (FIG. 7), the phoneme length is controlled on a phrase basis.

Also in the eighth embodiment, a phoneme length is multiplied by a fixed value according to the speaking rate (step S804). It is determined whether a reading speed is low and whether a phoneme is a prolonged sound or geminate consonant (step S805). If the reading speed is low and a phoneme is a prolonged sound or geminate consonant (YES in step S805), the phoneme length is multiplied by a predetermined value, for example, 0.8 (step S806). On the other hand, if the reading speed is low and a phoneme is not a prolonged sound or geminate consonant (NO in step S805), the phoneme length multiplied by a fixed value according to a speaking rate in step S804 is maintained.

After such processing, a phoneme number n is updated (n=n+1) (step S807), followed by determination as to completion of processing on phonemes in a phrase (step S808). The length of the last pause in a phrase is multiplied by a fixed value according to a speaking rate (step S809), followed by determination as to termination (step S801). Until processing of all data is completed, steps S803 to S810 are repeated. After the determination as to termination, speech synthesis is carried out (step S811), and a voice is output.

In this way, if a reading speed is low and a phoneme is a prolonged sound or geminate consonant, the phoneme length is shortened, and the other phonemes are set to a standard length. As a result, the phoneme length of the prolonged sound or geminate consonant is shorter than the length of the other phonemes. Hence, the entire length of a read sentence is maintained and in addition, a synthesized voice is easier to hear and recognition of a read speech is facilitated.

### Ninth Embodiment

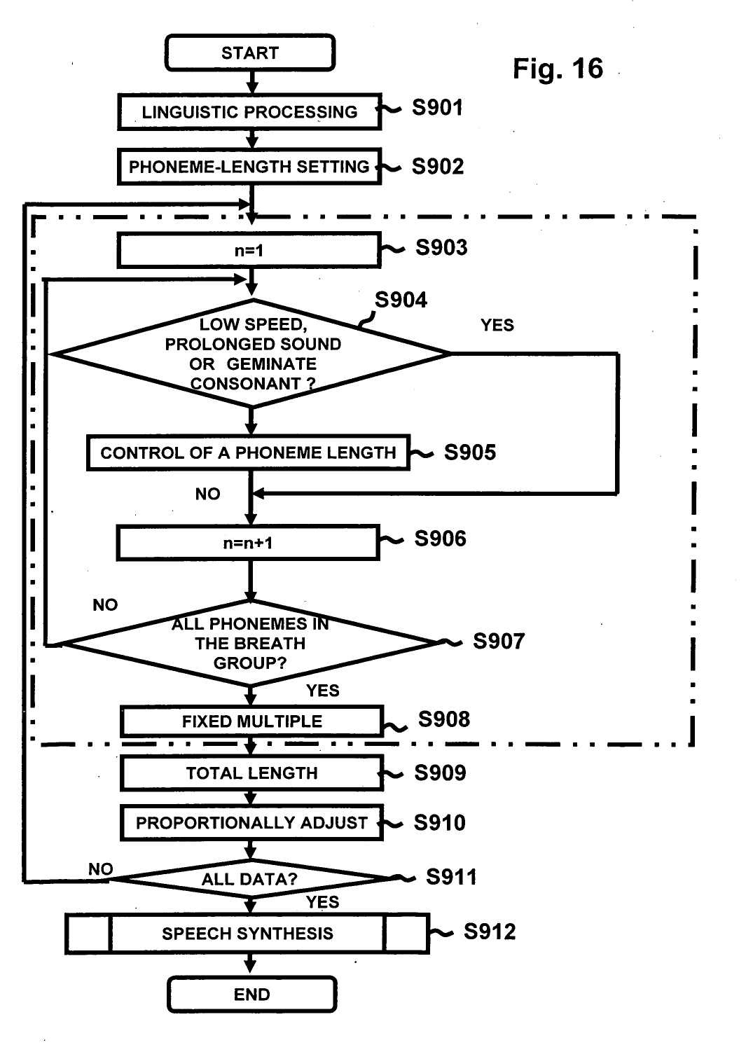

Next, a ninth embodiment of the present invention is described with reference to FIG. 16. FIG. 16 is a flowchart showing an example of a phoneme length control processing procedure of the ninth embodiment.

This processing procedure exemplifies the text to speech reading program or method and is executed using the above text to speech reading apparatus 2 (FIG. 1) and the phoneme length control unit 18 (FIG. 9). In the eighth embodiment, if a reading rate is low and a phoneme is a pause, or a prolonged sound or geminate consonant, the phoneme length is not increased, so lengths of phonemes other than the pause, or the prolonged sound or geminate consonant are multiplied by a fixed ratio and thus increased according to a speaking rate. In addition, the length corresponding to the unlengthened phoneme of the pause, or the prolonged sound or geminate consonant is proportionally allocated to all phonemes but the pause, or the prolonged sound or geminate consonant and thus increased on a phrase basis.

As shown in FIG. 16, in this processing procedure, language processing (step S901) and phoneme length setting processing (step S902) are executed. After that, as processing of phonemes in a phrase, a phoneme number n is initialized (n=1) (step S903) and a phoneme length is controlled based on a speaking rate (steps S904 to S909). Similar to the second embodiment (FIG. 7), the phoneme length is controlled on a phrase basis.

Also in the ninth embodiment, it is determined whether a reading speed is low and whether a phoneme is a pause or a prolonged sound or geminate consonant (step S904). If the reading speed is low and a phoneme is not a pause or a prolonged sound or geminate consonant (NO in step S904), the phoneme length is multiplied by a predetermined value according to a speaking rate (step S905). On the other hand, if the reading speed is low and a phoneme is not a pause or a prolonged sound or geminate consonant (YES in step S904), step S905 is skipped and a phoneme number n is updated (n=n+1) (step S906). After the determination as to completion of processing on phonemes in a phrase (step S907), the length of the last pause in the phrase is multiplied by a fixed value according to a speaking rate (step S908).

Further, the total phrase length is calculated (step S909), and the length is adjusted by proportionally allocating the length to phonemes other than the pause or the prolonged sound or geminate consonant such that the length of the phrase is equal to or almost equal to a predetermined length, for example, a length obtained when a phoneme length is not increased (step S910), followed by determination as to termination (step S911). Until processing of all data is completed, steps S903 to S911 are repeated. After the determination as to termination, speech synthesis is carried out (step S912), and a voice is output.

In this way, if a reading speed is low and a phoneme is a pause, or a prolonged sound or geminate consonant, the length corresponding to the unlengthened phoneme of the pause, or the prolonged sound or geminate consonant is proportionally allocated to all phonemes but the pause, or the prolonged sound or geminate consonant and thus increased on a phrase basis. Hence, the entire length of a read sentence is maintained and in addition, a synthesized voice is easier to hear and recognition of a read speech is facilitated.

### Tenth Embodiment

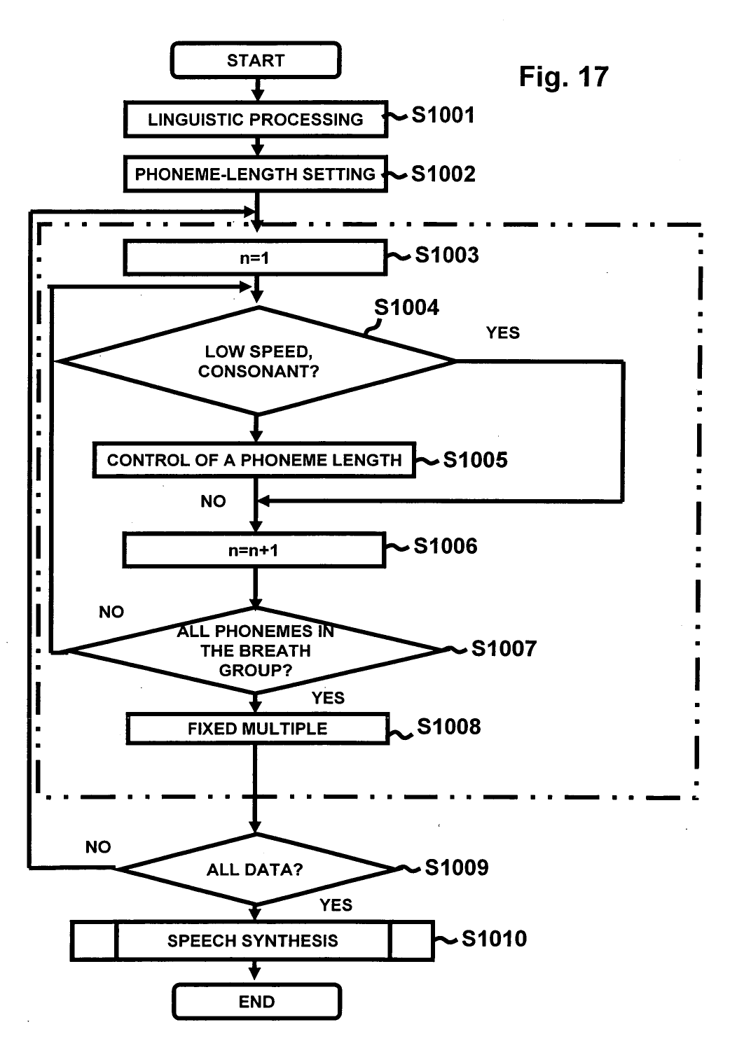

Next, a tenth embodiment of the present invention is described with reference to FIG. 17. FIG. 17 is a flowchart showing an example of a phoneme length control processing procedure of the tenth embodiment.

This processing procedure exemplifies the text to speech reading program or method and is executed using the above text to speech reading apparatus 2 (FIG. 1) and the phoneme length control unit 18 (FIG. 2). In the tenth embodiment, if a reading speed is low and a phoneme is consonant, the speed is kept at a standard speed not to increase the phoneme length.

As shown in FIG. 17, in this processing procedure, language processing (step S1001) and phoneme length setting processing (step S1002) are executed. After that, as processing of phonemes in a phrase, a phoneme number n is initialized (n=1) (step S1003).

Also in the tenth embodiment, it is determined whether a reading speed is low and whether a phoneme is a consonant (step S1004). If the reading speed is low and a phoneme is not a consonant (NO in step S1004), the phoneme length is multiplied by a predetermined value according to a speaking rate (step S1005). On the other hand, if the reading speed is low and a phoneme is consonant (YES in step S1004), step S1005 is skipped and a phoneme number n is updated (n=n+1) (step S1006). After the determination as to completion of processing on phonemes in a phrase (step S1007), the length of the last pause in the phrase is multiplied by a fixed value according to a speaking rate (step S1008), followed by determination as to termination (step S1009). Until processing of all data is completed, steps S1003 to S1009 are repeated. After the determination as to termination, speech synthesis is carried out (step S1010), and a voice is output.

In this way, if a reading speed is low and a phoneme is consonant, the phoneme length is not increased, that is, the speed is kept at a standard speed. Hence, a synthesized voice is easier to hear, and recognition of a read speech is facilitated.

### Eleventh Embodiment

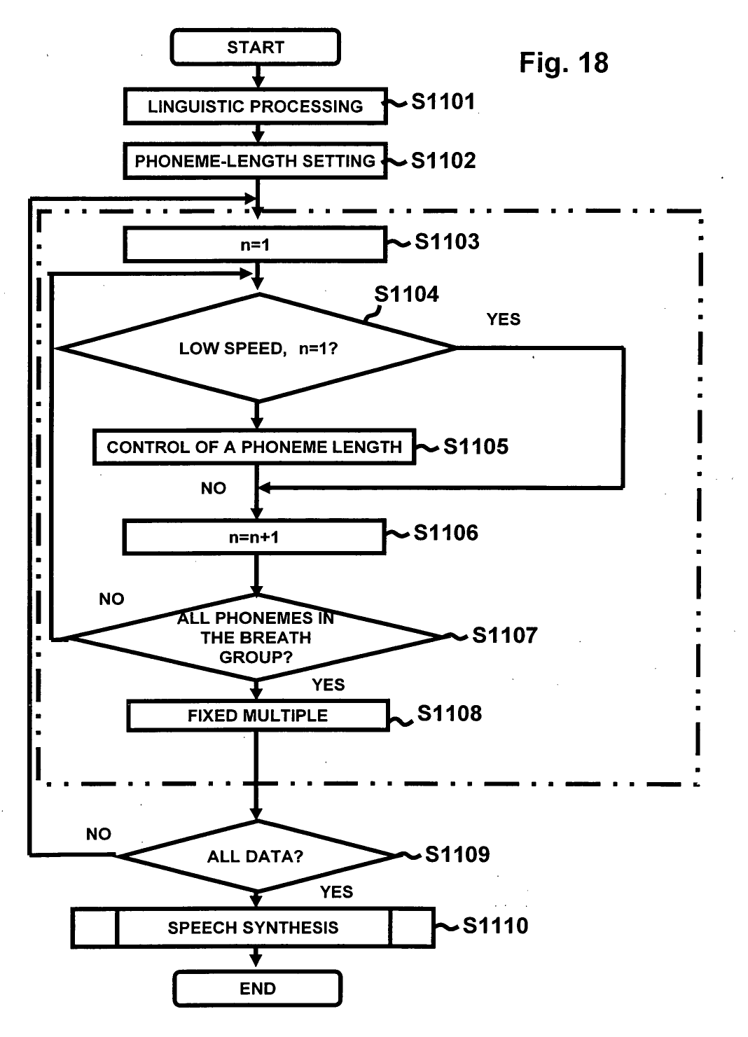

Next, an eleventh embodiment of the present invention is described with reference to FIG. 18. FIG. 18 is a flowchart showing an example of a phoneme length control processing procedure of the eleventh embodiment.

This processing procedure exemplifies the text to speech reading program or method and is executed using the above text to speech reading apparatus 2 (FIG. 1) and the phoneme length control unit 18 (FIG. 2). In the eleventh embodiment, if a reading speed is low and a phoneme is the top phoneme, the speed is kept at a standard speed not to increase the phoneme length.

As shown in FIG. 18, in this processing procedure, language processing (step S1101) and phoneme length setting processing (step S1102) are executed. After that, as processing of phonemes in a phrase, a phoneme number n is initialized (n=1) (step S1103).

Also in the eleventh embodiment, it is determined whether a reading speed is low and whether a phoneme is the top phoneme (step S1104). If the reading speed is low and a phoneme is not the top phoneme (n==1) (NO in step S1104), the phoneme length is multiplied by a predetermined value according to a speaking rate (step S1105). On the other hand, if the reading speed is low and a phoneme is the top phoneme (n==1) (YES in step S1104), the length of the first phoneme is kept at a standard length.

After such processing, a phoneme number n is updated (n=n+1) (step S1106), and the length of the last pause in a phrase is multiplied by a fixed value according to a speaking rate (step S1108), followed by determination as to termination (step S1109). Until processing of all data is completed, steps S1103 to S1109 are repeated. After the determination as to termination, speech synthesis is carried out (step S1110), and a voice is output.

In this way, if a reading speed is low and a phoneme is not the top phoneme, the phoneme length is multiplied by a fixed value and thus increased according to a speaking rate. If a phoneme is the top phoneme, the phoneme length is not increased, so a synthesized voice is easier to hear, and recognition of a read speech is facilitated.

### Twelfth Embodiment

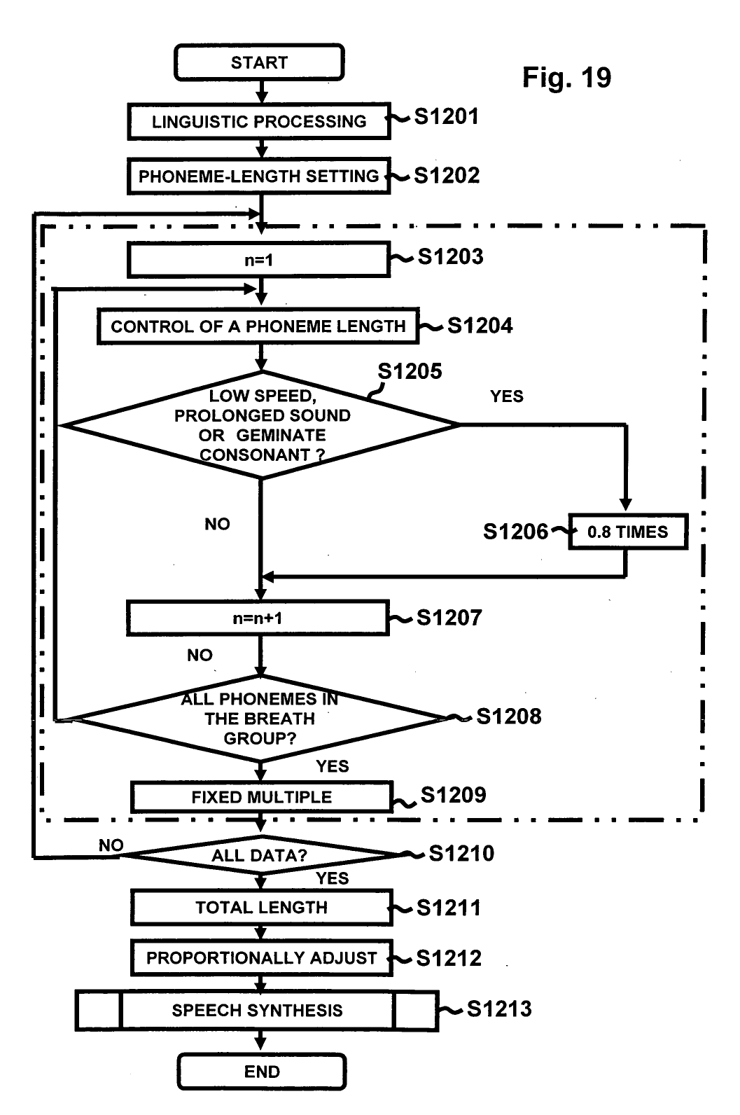

Next, a twelfth embodiment of the present invention is described with reference to FIG. 19. FIG. 19 is a flowchart showing an example of a phoneme length control processing procedure of the twelfth embodiment.

This processing procedure exemplifies the text to speech reading program or method and is executed using the above text to speech reading apparatus 2 (FIG. 1) and the phoneme length control unit 18 (FIG. 11). In the twelfth embodiment, a phoneme of a prolonged sound or geminate consonant is adjusted such as shortened, and the total length is adjusted by proportionally allocating the length corresponding to the adjustment to all phonemes in the text. Thus, a read speech that is easier to hear is realized while the entire length is substantially maintained, that is, a text to speech conversion time is not increased. To give an example thereof, a speaking rate is set lower than 0.8 times as high as a standard speed while a reduction ratio of a phoneme length is set to 0.8. In this case, similar to the seventh embodiment, when a phoneme length of a prolonged sound or geminate consonant is adjusted such as reduced, the length corresponding to the adjustment may be proportionally allocated to all phonemes but the prolonged sound or geminate consonant.

As shown in FIG. 19, in this processing procedure, language processing (step S1201) and phoneme length setting processing (step S1202) are executed. After that, as processing of phonemes in a phrase, a phoneme number n is initialized (n=1) (step S1203) and a phoneme length is controlled based on a speaking rate (steps S1204 to S1209) Similar to the second embodiment (FIG. 7), the phoneme length is controlled on a phrase basis.

Also in the twelfth embodiment, a phoneme length is multiplied by a fixed value according to the speaking rate (step S1204). It is determined whether a reading speed is low and whether a phoneme is a prolonged sound or geminate consonant (step S1205). If the reading speed is low and a phoneme is a prolonged sound or geminate consonant (YES in step S1205), the phoneme length is multiplied by a predetermined value, for example, 0.8 (step S1206). On the other hand, if the reading speed is low and a phoneme is not a prolonged sound or geminate consonant (NO in step S1205), the phoneme length multiplied by a fixed value according to a speaking rate in step S1204 is maintained.

After such processing, a phoneme number n is updated (n n+1) (step S1207), followed by determination as to completion of processing of phonemes in a phrase (step S1208). A length of the last pause in the phrase is multiplied by a fixed value according to a speaking rate (step S1209), followed by determination as to termination (step S1210). Upon the determination as to termination, it is determined whether processing of all data is completed. After the determination as to termination, the entire text length is calculated (step S1211), and the lengths of all phonemes are proportionally allocated and thus adjusted such that the text length is equal to or almost equal to a predetermined length, for example, a length obtained when the phoneme length is not reduced (step S1212), followed by speech synthesis (step S1213) to output a voice.

In this way, while the phoneme length of a prolonged sound or geminate consonant is reduced at the time of adjusting the phoneme length of the prolonged sound or geminate consonant upon low-speed reading, in this embodiment, the phonemes are lengthened on a text basis, so the entire length of a read text is maintained and in addition, a read speech does not sound drawn out and is easier to hear.

### Thirteenth Embodiment

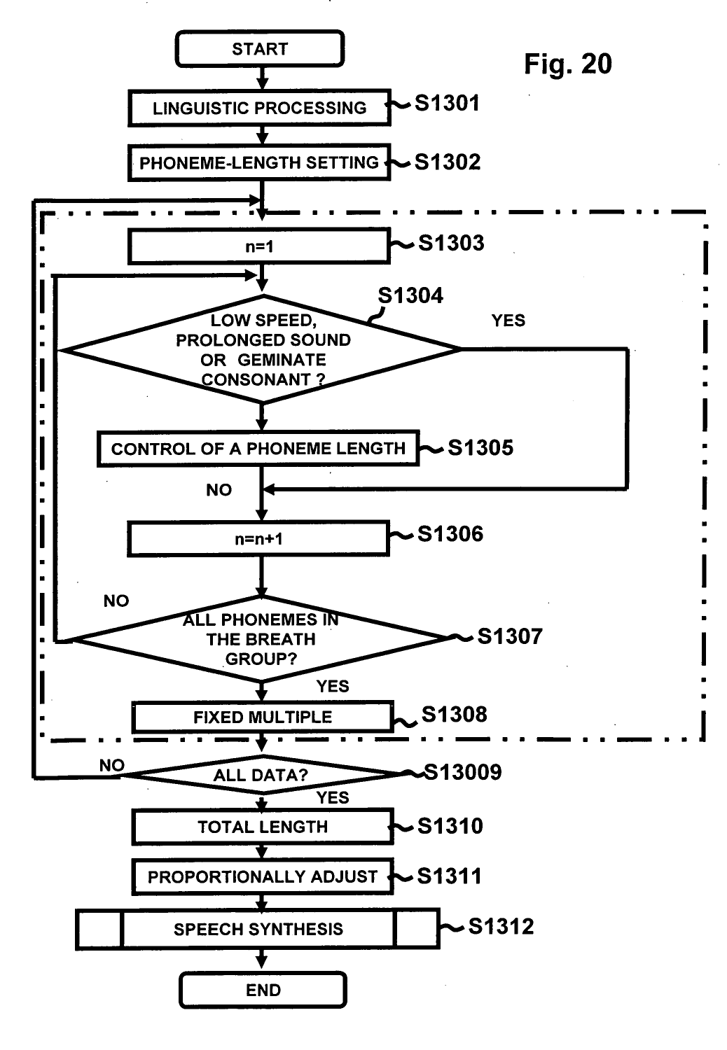

Next, a thirteenth embodiment of the present invention is described with reference to FIG. 20. FIG. 20 is a flowchart showing an example of a phoneme length control processing procedure of the thirteenth embodiment.

This processing procedure exemplifies the text to speech reading program or method and is executed using the above text to speech reading apparatus 2 (FIG. 1) and the phoneme length control unit 18 (FIG. 11). In the thirteenth embodiment, if a reading rate is low and a phoneme is a pause or a prolonged sound or geminate consonant, the phoneme length is adjusted, for example, not increased, so phonemes other than the pause or the prolonged sound or geminate consonant are multiplied by a fixed value and thus increased according to a speaking rate and in addition, the length corresponding to the unadjusted phoneme, that is, un unlengthened phoneme of the pause, or the prolonged sound or geminate consonant is proportionally allocated to all phonemes but the pause, or the prolonged sound or geminate consonant on a text basis. In this case, similar to the ninth embodiment, when the length of the pause, or the prolonged sound or geminate consonant is adjusted such as shortened, the length corresponding to the adjustment may be proportionally allocated to all phonemes but the pause, or the prolonged sound or geminate consonant.

As shown in FIG. 20, in this processing procedure, language processing (step S1301) and phoneme length setting processing (step S1302) are executed. After that, as processing of phonemes in a phrase, a phoneme number n is initialized (n=1) (step S1303) and a phoneme length is controlled based on a speaking rate (steps S1304 to S1308). Similar to the second embodiment (FIG. 7), the phoneme length is controlled on a phrase basis.

Also in the thirteenth embodiment, it is determined whether a reading speed is low and whether a phoneme is a pause or a prolonged sound or geminate consonant (step S1304). If the reading speed is low and a phoneme is not a pause or a prolonged sound or geminate consonant (No in step S1304), the phoneme length is multiplied by a fixed value according to a speaking rate (step S1305). On the other hand, if the reading speed is low and a phoneme is a pause or a prolonged sound or geminate consonant (YES in step S1304), step S1305 is skipped and a phoneme number n is updated (n=n+1) (step S1306) to determine whether all phonemes in a phrase have been processed (step S1307). Then, the length of the last pause in the phrase is multiplied by a fixed value (step S1308), followed by determination as to termination (step S1309). Upon the determination as to termination, it is determined whether processing of all data is completed. After the determination as to termination, the entire text length is calculated (step S1310), and the lengths of all phonemes are proportionally allocated and thus adjusted such that the text length is equal to or almost equal to a predetermined length, for example, a length obtained when the phoneme length is not increased (step S1311), followed by speech synthesis (step S1312) to output a voice.

In this way, instead of increasing a phoneme length of a pause or a prolonged sound or geminate consonant upon low-speed reading, in this embodiment, phonemes are lengthened on a text basis, so the entire length of a read text is maintained and in addition, a read speech does not sound drawn out and is easier to hear.

### Other Embodiments

The embodiments of the present invention are described above, but the scope of the present invention encompasses the other embodiments as described below.

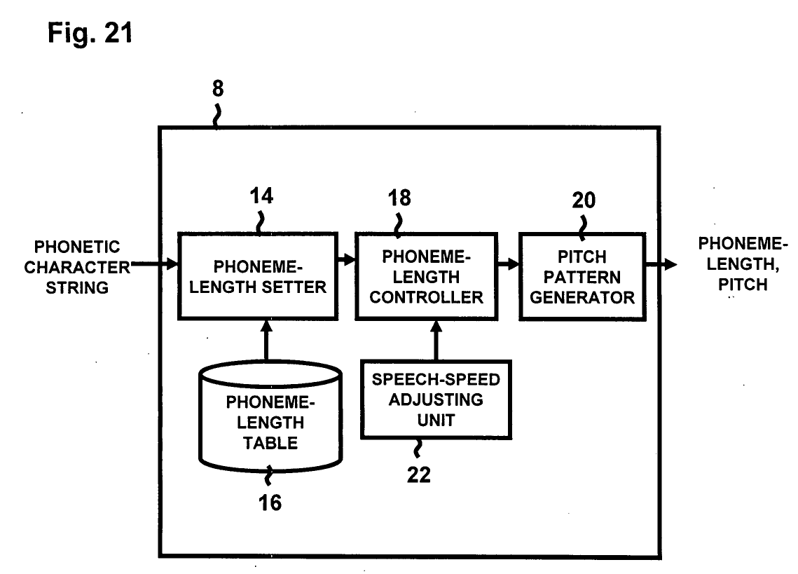

(1) The speaking rate information input to the phoneme length control unit 18 is described with reference to FIG. 21. FIG. 21 is a block diagram showing the parameter generating unit provided with a speaking rate adjustment unit. In the above embodiments, the speaking rate information is input to the phoneme length control unit 18, but as shown in FIG. 21, a speaking rate adjustment unit 22 capable of externally adjusting a speaking rate may be provided in the parameter generating unit 8 to externally set a desired speaking rate.

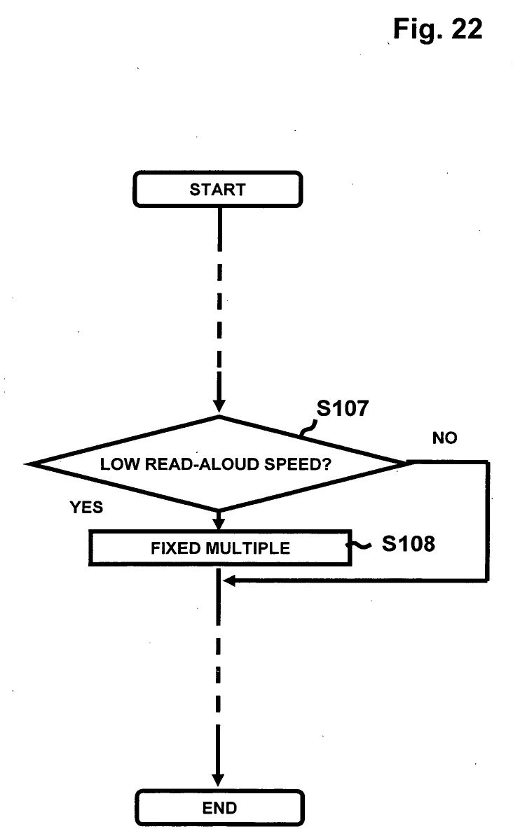

(2) In the first embodiment the length of the last pause in a phrase is multiplied by a fixed value according to a speaking rate if a reading speed is not low. However, as shown in FIG. 22, the following configuration may be adopted. That is, it is determined whether the reading speed is low (step S107), and if the reading speed is low (YES in step S107), the length of the last pause in a phrase is multiplied by a fixed value and thus increased according to a speaking rate. If the reading speed is not low (NO in step S107), the pause length is not changed. More specifically, if a reading speed is high, the pause length is not shortened, and a read speech is easier to hear.

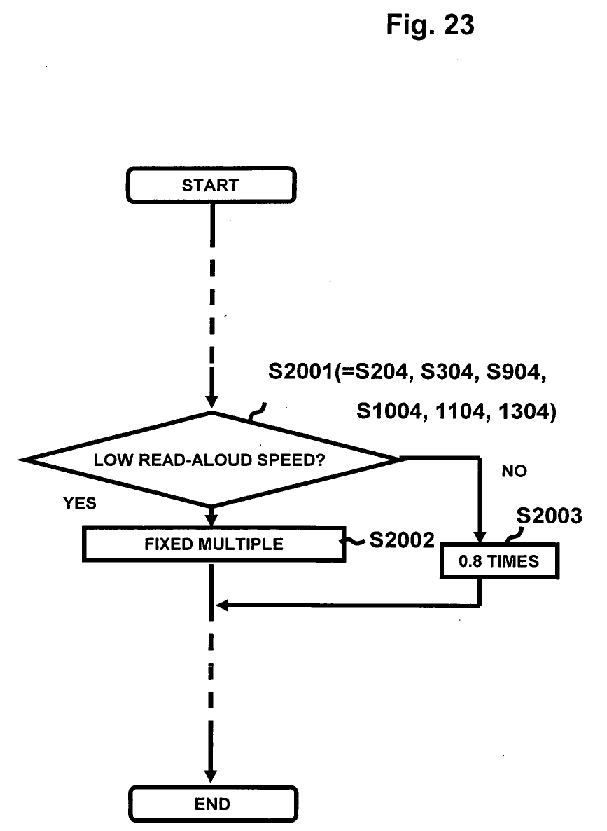

(3) A flowchart of FIG. 23 is a modified example of the flowcharts of the second embodiment (FIG. 7), the third embodiment (FIG. 8), the ninth embodiment (FIG. 16), the tenth embodiment (FIG. 17), the eleventh embodiment (FIG. 18), and the thirteenth embodiment (FIG. 20). In FIG. 23, step S2001 corresponds to steps S204, S304, S904, S1004, S1104, and S1304. In the above embodiments, when the phoneme length is multiplied by a fixed value according to a speaking rate (step S2002), step S2003 may be executed to multiply the phoneme length by 0.8 as processing for shortening the phoneme length.

(4) As for the processing executed on a phrase basis, in the fourth embodiment (FIG. 10), the length corresponding to the adjustment of the phoneme length is proportionally allocated to all phonemes but a pause (step S410). In the seventh embodiment (FIG. 14), if a reading speed is low, and a phoneme is a prolonged sound or geminate consonant, the length corresponding to the shortened length of the prolonged sound or geminate consonant is proportionally allocated to all phonemes but the prolonged sound or geminate consonant (step S711). In the ninth embodiment (FIG. 16), if a reading speed is low, and a phoneme is a pause, or a prolonged sound or geminate consonant, the length corresponding to the shortened length of the pause or the prolonged sound or geminate consonant is proportionally allocated to all phonemes but the pause or the prolonged sound or geminate consonant (step S910). In this way, the phoneme length is proportionally allocated on a phrase basis. However, this processing may be carried out by proportionally allocating the length corresponding to the adjustment on phonemes other than the pause or the prolonged sound or geminate consonant, for example, consonant to all phonemes.

(5) As for the processing executed on a text basis, in the fifth embodiment (FIG. 12), the twelfth embodiment (FIG. 19), and the thirteen embodiment (FIG. 20), the phoneme length is proportionally allocated on a text basis such that the entire text length is equal to or almost equal to a predetermined length. However, this processing may be carried out by proportionally allocating the length corresponding to the adjustment on phonemes other than the pause or the prolonged sound or geminate consonant, for example, consonant to all phonemes. In this case, similar to the processing executed on a phrase basis, in the processing executed on a text basis, when the phoneme length of the pause, the prolonged sound or geminate consonant, or the consonant is adjusted, the lengths of phonemes in the entire text excluding the length corresponding to the adjustment may be proportionally allocated to the other phonemes.

(6) In the first embodiment, the portable terminal device 200 (FIGS. 3 and 4) is used by way of example, but the present invention is applicable to an electronic device incorporating a computer and outputting a voice such as a personal digital assistant (PDA) or a personal computer or various types of devices including an electronic device unit. The present invention is not limited to the above embodiments.

### EXAMPLES

### Example 1

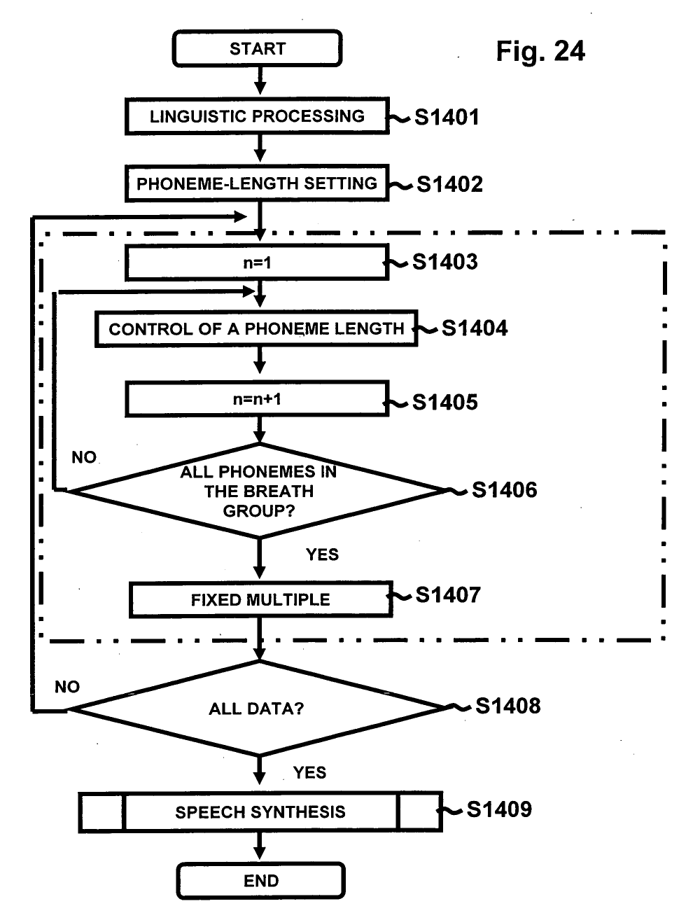

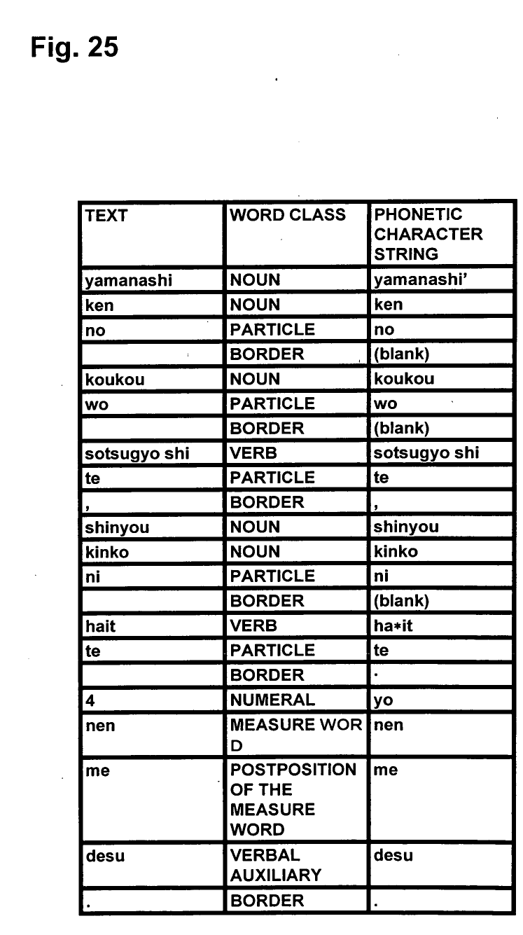

Example 1 is described with reference to FIGS. 24 and 25. FIG. 24 is a flowchart as a comparative example of the flowchart of FIG. 6, and FIG. 25 shows a language processing result.

In the text to speech reading apparatus 2 (FIG. 1), if the lengths of phonemes are similarly increased according to a speaking rate, the processing in the flowchart of FIG. 24 is executed, and a length of a phoneme following a pause is not adjusted. That is, the flowchart of FIG. 24 corresponds to the flowchart of FIG. 6 excluding step S107. As apparent from language processing (step S1401), phoneme length setting processing (step S1402), initialization of a phoneme number (step S1403), multiplication of a phoneme length by a fixed value (step S1404), update of a phoneme number (step S1405), determination as to completion of processing of phonemes in a phrase (step S1406), multiplication of a length of the last pause (step S1407), determination as to termination (step S1408), and speech synthesis (step S1409), a phoneme length or a length of the last pause is multiplied by a fixed value according to a speaking rate.

In this processing, if the following text “yamanashikennokoukouwosotsugyoushite, shinyoukinkonihaitte4nenmedesu.” (FIG. 5) is input, words can be analyzed in categories of “input text”, “part of speech”, and “phonogram string” as shown in FIG. 25.

In the text “yamanashikennokoukouwosotsugyoushite, shinyoukinkonihaitte4nenmedesu.”, “yamanashi” is a noun. A phonogram string thereof is [yamanashi'], and “ken” is a noun. A phonogram string thereof is [ken], and “no” is a particle. A phonogram string thereof is [no]. An unvoiced duration follows the “no” due to an accent phrase boundary, and “koukou” is a noun. Its phonogram string is [koukou], and “wo” is a particle. Its phonogram string is [o]. An unvoiced duration follows the “no” due to an accent phrase boundary, and “sotsugyoushi” is a verbal (continuous clauses). Its phonogram string is [sotsugyoushi], and “te” is a particle. Its phonogram string is [te], and “,” is a phrase boundary (intermediate pause length). Its phonogram string is [,], and “shinyo” is a noun. Its phonogram string is [shinyo], and “kinko” is a noun. Its phonogram string is [k'inko], and “ni” is a particular. Its phonogram string is [ni]. An unvoiced duration follows the “ni” due to an accent phrase boundary, and “haitt” is a verval (continuous clauses with a geminate consonant). Its phonogram string is [ha*itt], and “te” is a particle. Its phonogram string is [te], and a phrase boundary (short pause length) follows the “te”. Its phonogram string is [.], and “4” is a numeral. Its phonogram string is [yo], and “nen” is a counter. Its phonogram string is [nen], and “me” is a postposition of the counter. Its phonogram string is [me'], and “desu” is an auxiliary verb. Its phonogram string is [desu], and “.” is a phrase boundary (long pause length). Its phonogram string is [.]. Accordingly, the phonogram string of the above text is [yamanashi'kennno koukouo sotsugyoushite, shinyoki'nkoni ha*itte.yonennme'desu.”. In FIG. 25, the input text and phonetic character strings are written by using Roman characters, but the input text is different from phonetic character strings as data. In other words, the text to speech reading apparatus 2 transforms the input text into phonetic character strings.

### Example 2

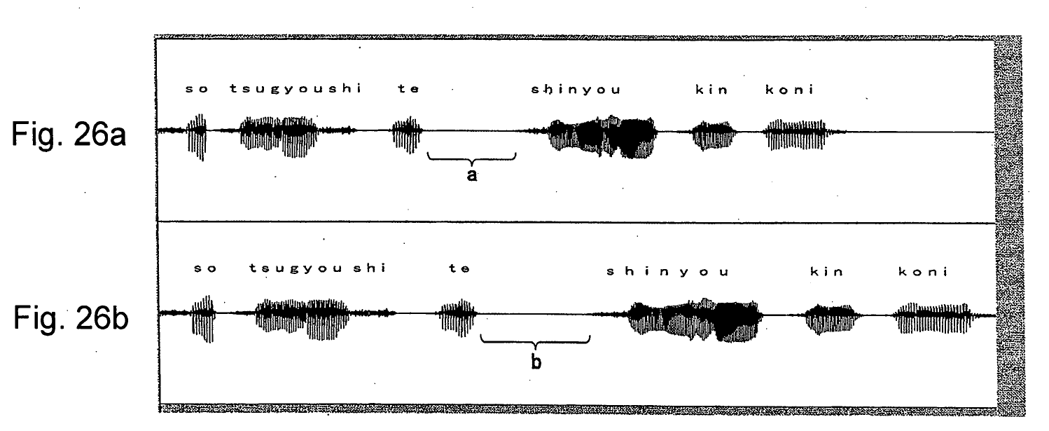

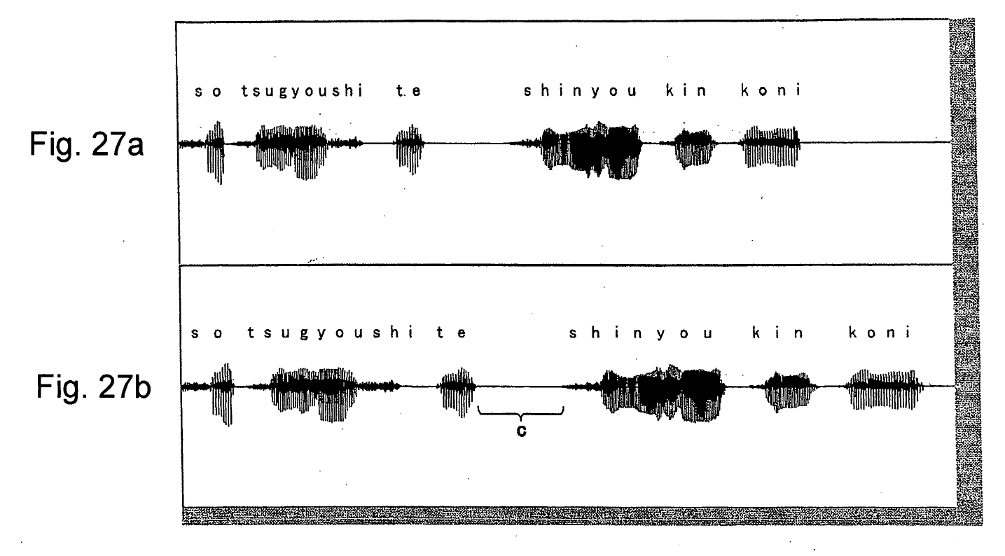

Example 2 is an example of the first embodiment (a pause length is not increased). A waveform representing a processing result of Example 2 is described with reference to FIGS. 26 and 27. FIG. 26 shows a synthesized voice waveform as a comparative example. FIG. 27 shows a synthesized voice waveform of Example 2. A waveform in FIG. 26a is obtained at a standard speed and a waveform in FIG. 26b is obtained at a low reading speed. A portion a of the waveform in FIG. 26a and a portion b of the waveform in FIG. 26b represent a pause duration.

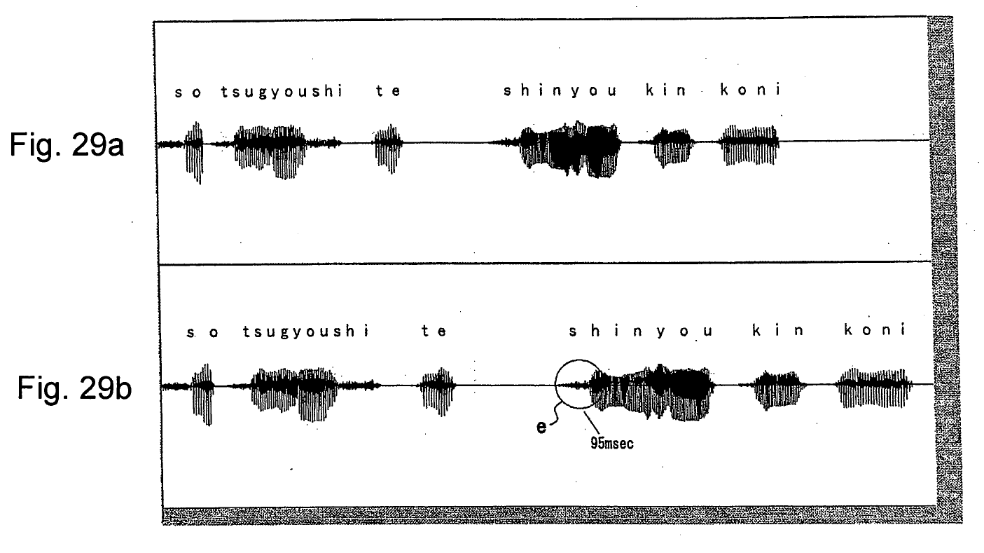

In contrast, a waveform in FIG. 29a is obtained at a standard speed in the processing of the tenth embodiment (flowcharts of FIGS. 16 and 17). A waveform B is obtained at a low reading speed. A phoneme length of consonant is short at the beginning of a portion e as compared with a speaking rate ratio.

### Example 3

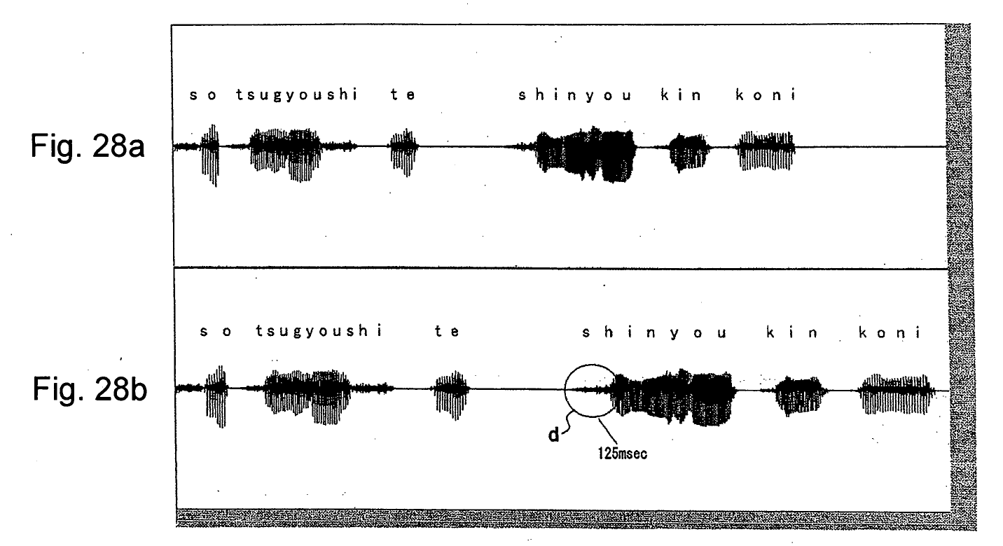

Example 3 an example of the tenth embodiment (a phoneme length of a consonant is not increased or shortened) and the eleventh embodiment (a length of the top phoneme is not increased or shortened). A waveform representing a processing result of Example 4 is described with reference to FIGS. 28 and 29. FIG. 28 shows a synthesized voice waveform as a comparative example. FIG. 29 shows a synthesized voice waveform of Example 3, a waveform in FIG. 28a is obtained at a standard speed and a waveform B is obtained at a low reading speed. In the waveform in FIG. 28b, a phoneme length of a consonant is 125 [msec] at the beginning of a portion d. This value corresponds to a speaking rate ratio.

In contrast, a waveform in FIG. 29a is obtained at a standard speed in the processing of the ninth and tenth embodiments (flowcharts of FIGS. 16 and 17). A waveform B is obtained at a low reading speed. A phoneme length of consonant is short at the beginning of a portion e as compared with a speaking rate ratio.

### Example 4

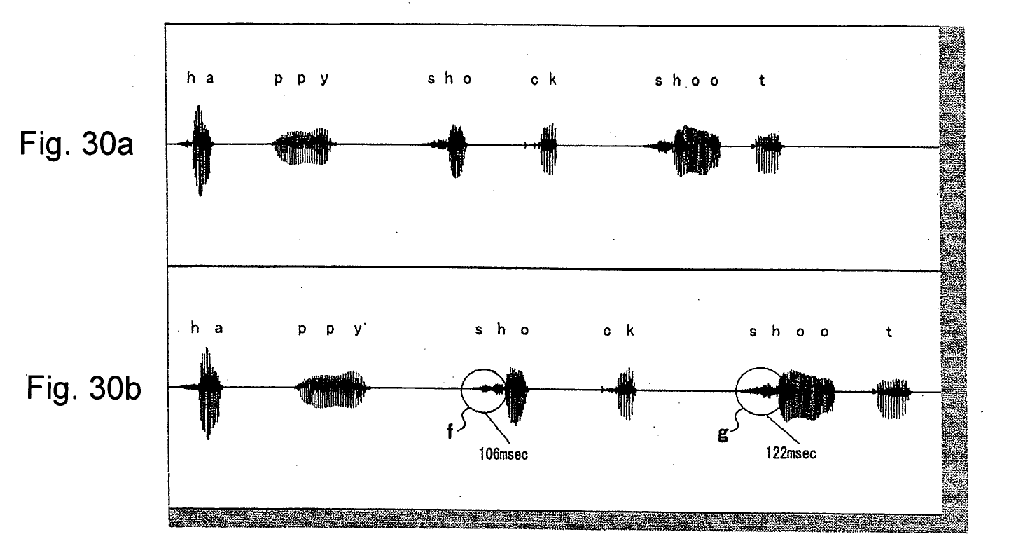

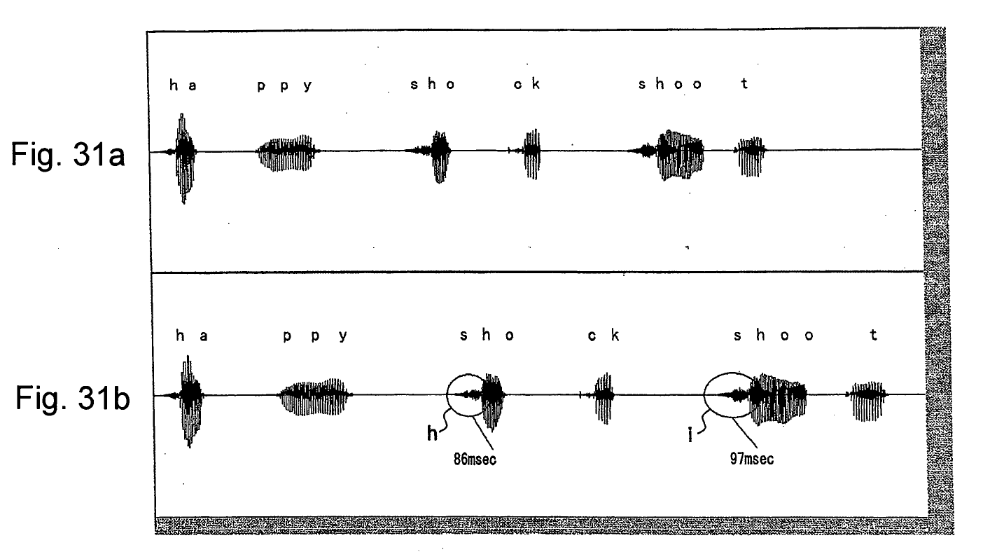

Example 4 is an example of the tenth embodiment (a phoneme length of a consonant is not increased or shortened) and the eleventh embodiment (a length of the top phoneme is not increased or shortened). A waveform representing a processing result of Example 4 is described with reference to FIGS. 30 and 31. FIG. 30 shows a synthesized voice waveform as a comparative example. FIG. 31 shows a synthesized voice waveform of Example 4. Examples 1, 2, and 3 describe the case of reading a Japanese text, while Example 4 describes the case of reading an English text “ha-ppy, sho-ck, shoo-t”. A waveform in FIG. 30a, is obtained at a standard speed and a waveform B is obtained at a low reading speed. In the waveform B of FIG. 30, a phoneme length of a consonant is 106 [msec] at the beginning of a portion d. Similarly, a phoneme length of a consonant is 122 [msec] in a portion d. This value corresponds to a speaking rate ratio.

In contrast, a waveform in FIG. 31a is obtained at a standard speed in the processing of the ninth and tenth embodiments (flowcharts of FIGS. 16 and 17). A waveform B is obtained at a low reading speed. A phoneme length of consonant is 86 [msec] at the beginning of a portion h and similarly 97 [msec] at the beginning of a portion i. The length is not increased, that is, shortened as compared with a speaking rate ratio.

### Example 5

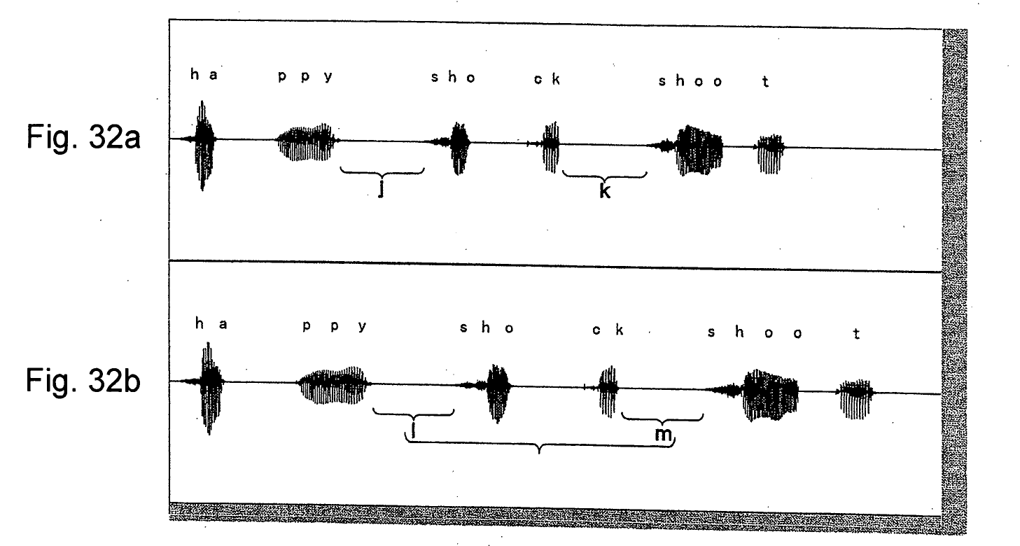

Example 5 is an example of the first embodiment (a pause length is not increased). Example 4 describes the case of reading an English text “ha ppy, sho ck, shoo t”. A waveform representing a processing result of Example 5 is described with reference to FIG. 32. a waveform in FIG. 32a is obtained at a standard speed and a waveform B is obtained at a low reading speed. The waveform B is extended compared with the waveform A due to the low reading speed, but in pause durations l and m only, the waveforms A and B have the same length as in pause durations j and k without increasing the phoneme length.

Next, technical ideas that can be derived from the above embodiments of the present invention are listed.

What is claimed is:

1. An apparatus for converting text data into sound signal, comprising:
a phoneme determiner for determining phoneme data corresponding to a plurality of phonemes and pause data corresponding to a plurality of pauses to be inserted among a series of phonemes in the text data to be converted into sound signal;
a phoneme length adjuster for modifying the phoneme data and the pause data by determining lengths of the phonemes, respectively in accordance with a speed of the sound signal and selectively reducing the length of at least one of the pause in the text data to a pause length which is less than the pause length corresponding to the speed of the sound signal; and
an output unit for outputting sound signal on the basis of the adjusted phoneme data and pause data by the phoneme length adjuster.

2. The apparatus according to claim 1, further comprising:
a speed determiner for determining a speed of the sound signal;
wherein when the speed determiner determines that the speed of the sound signal is lower than predetermined speed, the phoneme length adjuster modifies the phoneme data by shortening a length of the phoneme.

3. The apparatus according to claim 1, further comprising:
a breath-group calculator for calculating a length of a breath group; wherein the phoneme length adjuster modifies the phoneme data and pause data by increasing or reducing proportionally phoneme lengths and pause lengths in the breath group in accordance with the length of the breath group.

4. The apparatus according to claim 1, further comprising:
a sentence calculator for calculating a length of a read-aloud sentence of the text data;
wherein the phoneme length adjuster proportionally modifies the phoneme data and pause data by increasing or reducing proportionally phoneme lengths and pause lengths in the sentence in accordance with the length of the read-aloud sentence of the text data.

5. A method for converting text data into sound signal, comprising the steps of:
determining phoneme data corresponding to a plurality of phonemes and pause data corresponding to a plurality of pauses to be inserted among a series of phonemes in the text data to be converted into sound signal;
modifying the phoneme data and the pause data by determining lengths of the phonemes, respectively in accordance with a speed of the sound signal and selectively reducing the length of at least one of the pause in the text data to a pause length which is less than the pause length corresponding to the speed of the sound signal; and
outputting sound signal on the basis of the adjusted phoneme data and pause data.

6. The method according to claim 5, further comprising the steps of:
determining a speed of the sound signal; and
modifying the phoneme data by shortening a length of the phoneme the speed of the sound signal is lower than predetermined speed.

7. The method according to claim 5, further comprising the steps of:
calculating a length of a breath group; and
modifying the phoneme data by increasing or reducing proportionally phoneme lengths in the breath group in accordance with the length of the length of the breath group.

8. The method according to claim 5, further comprising the steps of:
calculating a length of a read-aloud sentence of the text data; and
modifying the phoneme data by increasing or reducing proportionally phoneme lengths in the sentence in accordance with the length of the read-aloud sentence of the text data.

9. An apparatus for converting text data into sound signal, comprising:
a processor for performing a process of converting the text data into sound signal comprising the steps of:
determining phoneme data corresponding to a plurality of phonemes and pause data corresponding to a plurality of pauses to be inserted among a series of phonemes in the text data to be converted into sound signal;
modifying the phoneme data and the pause data by determining lengths of the phonemes, respectively in accordance with a speed of the sound signal and selectively reducing the length of at least one of the pause in the text data to a pause length which is less than the pause length corresponding to the speed of the sound signal; and
an output unit for outputting sound signal on the basis of the adjusted phoneme data and pause data.
